(19) United States
(12) Patent Application Publication
(10) Pub. No.: US 2023/0147974 A1
(43) Pub. Date: May 11, 2023

(54) PICK ASSIST SYSTEM

(71) Applicant: Rehrig Pacific Company, Los Angeles, CA (US)

(72) Inventors: Robert Lee Martin, JR., Lucas, TX (US); Peter Douglas Jackson, Alpharetta, GA (US); Steven Stavro, Santa Monica, CA (US); Daniel James Thyer, Charlotte, NC (US); Justin Michael Brown, Coppell, TX (US); Vance Asher Weintraub, Denton, TX (US)

(21) Appl. No.: 17/984,572

(22) Filed: Nov. 10, 2022

Related U.S. Application Data
(60) Provisional application No. 63/397,184, filed on Aug. 11, 2022.
(60) Provisional application No. 63/277,769, filed on Nov. 10, 2021.

(51) Int. Cl. B66F 9/06; B65G 1/137; B65G 59/06; B66F 9/075

(52) U.S. Cl. CPC B66F 9/063; B65G 1/1371; B65G 59/06; B66F 9/0755; B65G 2203/046; B65G 2203/041

(57) ABSTRACT

A pick assist system may include a pallet destacker storing a front column of pallets and a back column of pallets. At least one rfid reader is configured to read an rfid tag on a pallet in or below at least one of the front column of pallets or the back column of pallets. The pick assist system may include a pallet sled including a display indicating a product to be retrieved. The pallet sled may determine that the product has been placed in a center of a pallet on the pallet sled. A method for verifying a pallet may include identifying skus on exterior products in a layer in a stack of products. Based upon that determination, the skus of the interior products may also be determined. For example, it may be determined that the interior products were part of a layer pick.

### BACKGROUND

The delivery of products to stores from distribution centers has many steps that have the potential for errors and inefficiencies. When the order from the store is received, at least one pallet is loaded with the specified products according to a “pick list” indicating a quantity of each product to be delivered to the store.

For example, the products may be cases of beverage containers (e.g. cartons of cans, beverage crates containing bottles or cans, cardboard trays with plastic overwrap containing cans or bottles, etc). There are numerous permutations of flavors, sizes, and types of beverage containers delivered to each store. When building pallets, missing or mis-picked product can account for significant additional operating costs.

### SUMMARY

A pick assist system provides several novel features, each of which could be practiced independently of the others, but some of which achieve additional benefit when practiced together.

One of the features provided in the pick assist system is a pallet destacker (or pallet dispenser). The pallet destacker includes a vertical body configured to store a front column of pallets and a back column of pallet. At least one rfid reader is configured to read an rfid tag on a pallet in or below at least one of the front column of pallets or the back column of pallets.

The at least one rfid reader may include a front rfid reader positioned to read the rfid tag of a pallet in or below the front column of pallets and a back rfid reader positioned to read the rfid tag of a pallet in or below the back column of pallets.

The pallet destacker may be used in combination with a validation system including at least one camera for imaging a plurality of items stacked on a pallet. At least one processor may be programmed to identify skus of the plurality of items stacked on the pallet based upon images from the at least one camera. The at least one processor may be programmed to compare the identified skus to a list of desired skus based upon a pallet id of the pallet. The at least one processor may be programmed to identify the pallet id of the pallet based upon the rfid tag on the pallet read by the at least one rfid reader in the destacker.

Another feature disclosed herein relates to a method for dispensing pallets. A plurality of pallets including a bottom pallet are stored in a stack. The plurality of pallets other than the bottom pallet are lifted off the bottom pallet. An identifier on the bottom pallet is read. The bottom pallet is moved laterally away from the stack.

The bottom pallet may be read before or during moving the bottom pallet away from the stack.

Optionally, the stack may be a first stack and the steps of dispensing and reading may be performed for a second stack of pallets while they are performed for the first stack.

Reading the identifier may include reading an rfid tag.

As another optional feature, the bottom pallets of the first stack and the second stack may be lifted on tines of a pallet sled, such that the bottom pallet of the first stack is a front pallet and the bottom pallet of the second stack is a back pallet on the tines of the pallet sled.

The identifiers may be communicated to at least one processor on the pallet sled. The identifier of the front pallet may be associated to the front pallet and the identifier of the back pallet may be associated to the back pallet.

In another independent feature disclosed herein, a display on a pallet sled displays a product to be retrieved. It is determined that the product has been placed in a center of a pallet on the pallet sled (i.e. such that it is or will be or might be in an interior of a stack and not visible from the exterior sides).

There are several ways of determining that the product has been placed in a center of a pallet on the pallet sled. In one technique, a confirmation is received from a user that the product has been placed in a center of the pallet. In other technique, a user is instructed to place the product in the center of the pallet.

The method may further include placing a plurality of products including the first product in a stack on the pallet such that the first product is not visible from an exterior of the stack. The plurality of products may include a plurality of exterior products that are visible from the exterior of the stack. A plurality of images of the stack is received. Skus of each of the plurality of exterior products in the stack are identified. A sku of the first product is then determined based upon the skus of the exterior products. The skus of the plurality of exterior products and the sku of the first product are compared to a list of desired skus.

The method may further include determining that the product was in a layer pick. The determination that the product was in the center of the pallet (interior of the stack) may be based upon the determination that the product was in a layer pick.

Another method disclosed herein relates to loading and verifying a pallet. It is indicated on a display on a pallet sled a desired number of a product to be retrieved. A user is asked for a count of how many of the product was retrieved. The count is compared to the desired number of the product. Based upon the comparison, the user is asked why the count is less than the desired number.

The user may be asked why the count is low using the display.

A menu of a plurality of reasons why the count might be low is presented to the user.

Another method described herein relates verifying a pallet. A plurality of images of a plurality of products in a stack are received. The plurality of products includes a plurality of exterior products that are visible from the exterior of the stack. At least one processor identifies skus of each of the plurality of exterior products in the stack, including a plurality of exterior products in a layer. The skus of each of the plurality of exterior products in the layer are determined to be the same. d) based upon step c), determining that at least one interior product not visible in the plurality of images has the same sku as the plurality of exterior products.

The plurality of exterior products in the layer may be all of the exterior products in the layer.

The skus of the plurality of exterior products may be compared to the sku of the at least one interior product to a list of desired skus.

At least one processor may infer the skus of each of the plurality of exterior products using at least one machine learning model.

### BRIEF DESCRIPTION OF THE DRAWINGS

FIG. 1 is a schematic view of a delivery system.

FIG. 2 is a flowchart of one version of a method for delivering items.

FIG. 3 shows an example loading station of the delivery system of FIG. 1.

FIG. 4 shows an example validation station of the delivery system of FIG. 1.

FIG. 5 is another view of the example validation system of FIG. 4 with a loaded pallet thereon.

FIG. 6 shows yet another example validation system of the delivery system of FIG. 1.

FIG. 7 shows portions of a plurality of machine learning models.

FIG. 8 is a flowchart showing a method for creating the machine learning models of FIG. 7.

FIG. 9 shows sample text descriptions of a plurality of sample SKUs, including how SKUs are identified by both package type and brand.

FIG. 10 is a flowchart of a sku identification method.

FIG. 11 illustrates the step of detecting the package faces on each side of the stack of items.

FIG. 12 illustrates four pallet faces of a loaded pallet.

FIG. 12A shows stitching all package faces together for one of the packages from the pallet faces in FIG. 12.

FIG. 12B shows stitching all package faces together for another one of the packages from the pallet faces in FIG. 12.

FIG. 12C shows stitching all package faces together for another one of the packages from the pallet faces in FIG. 12.

FIG. 12D shows stitching all package faces together for another one of the packages from the pallet faces in FIG. 12.

FIGS. 13 and 14 illustrate the step of selecting the best package type from the stitched package faces.

FIG. 15 shows an example of a plurality stitched images and selecting the best brand from among the plurality of stitched images.

FIG. 16 shows a flowchart for a SKU set heuristic.

FIG. 17 shows one possible architecture of the training feature of the system of FIG. 1.

FIG. 18 is a flowchart of one version of a method for training a machine learning model.

FIG. 19 shows an example screen indicating a validated loaded pallet at the distribution center.

FIG. 20 shows an example screen indicating a mis-picked loaded pallet at the distribution center.

FIG. 21 shows one possible implementation of a pick system.

FIG. 22 is a front perspective view of the pick system of FIG. 21.

FIG. 23 shows one screen on the mobile device 4 of the pick system of FIG. 21.

FIG. 24 shows a screen on the mobile device in which the mobile device takes a picture of the picker.

FIG. 24A an operator level screen on the mobile device where the picker can choose a skill level.

FIG. 24B shows a metrics screen on the mobile device.

FIG. 25 shows the pick system and a plurality of products arranged on shelves throughout a distribution center.

FIG. 26 shows a next product screen displayed on the mobile device.

FIG. 27 shows a camera of the mobile device taking images of each product retrieved by the user as the user approaches the pallet sled.

FIG. 28 shows the pallet sled with the mobile device indicating the location to place the next product.

FIG. 29 shows the mobile device of FIG. 28 showing a 3D representation of the partially-loaded pallets and an indication of the location to place the next product.

FIG. 30 shows the pallet sled with the mobile device indicating that the product has been placed in the correct location on the pallets and on the stack of products.

FIG. 31 shows the pallet sled with the mobile device indicating that the product has been placed in an incorrect location on the pallets and on the stack of products.

FIG. 31A shows the mobile device displaying a request for a number of items picked by the user.

FIG. 31B shows a screen of the mobile device requesting a reason from the user why the count was short.

FIG. 31C shows a screen of the mobile device instructing the user how to get to the next pick item.

FIG. 31D shows an error screen of the mobile device.

FIG. 31E shows a screen of the mobile device instructing the user to take the pallet to a particular quality control location.

FIG. 31F shows a screen of the mobile device instructing the user to take the pallet to a particular loading bay or truck door.

FIG. 31G shows a pallet complete screen of the mobile device.

FIG. 31H shows a performance screen on the mobile device indicating the user's statistics and ranking for the day.

FIG. 32 shows a screen of the mobile device instructing the picker which validation station to take the pallets.

FIG. 33 shows another example pallet sled incorporated as an automated guided vehicle that could be used in the pick system of FIG. 21.

FIG. 34 shows two of the pallet sleds of FIG. 33.

FIG. 35 shows the pallet sled of FIG. 33 approaching a pallet destacker.

FIG. 36 shows the pallet sled and pallet destacker of FIG. 35, with the pallet sled retrieving two empty pallets from the pallet destacker.

FIG. 36A is a side view of the pallet destacker, broken away with some components shown schematically.

FIGS. 37 and 38 illustrate a particular method that can be used with the automated guided vehicle pallet sleds.

FIG. 39 shows the pallet sled of FIG. 33 bringing two loaded pallets to a validation station.

FIG. 40 shows a pallet on a turntable of a validation station

FIG. 41 illustrates a variation of the pallet sled including smart glasses.

FIG. 42 shows the glasses of FIG. 41 confirming the selection of the next product and indicating a location to place the next product.

FIG. 43 is another view of the user wearing the glasses of FIG. 22 and placing the next product onto the pallets.

FIG. 44 shows a pallet sled with a full-size pallet thereon.

FIG. 45 shows two optional center confirmation screens that can be displayed on the mobile device of the pallet sled of FIG. 44.

FIG. 45A shows an interrogation screen in which the mobile device asks the user how many items were placed in the center of the pallet.

FIG. 46 is a flowchart using confirmation of center placement to validate a pallet.

FIG. 47 is a flowchart of another method for center placement validation.

FIG. 48 shows a first screen for the user to create the map.

FIG. 49 shows a screen enabling a user to choose from among several items to place on the map.

FIG. 50 shows a Pick Item screen.

FIG. 51 shows a screen in which the user has added all of the Pick Items to the map.

FIG. 52 shows a screen in which the user has selected “Walking Paths” and has added the walking paths (between the pick items) to the map.

FIG. 53 shows a “walls” user screen in which the user can add the walls to the map.

FIG. 54 shows a “loading bay” screen for the user to add loading bays to the map.

FIG. 55 shows a “QC Station” screen in which the user identifies the locations of several QC stations.

FIG. 56 shows a “wrapper” screen in which the user can identify the locations of wrappers.

### DETAILED DESCRIPTION

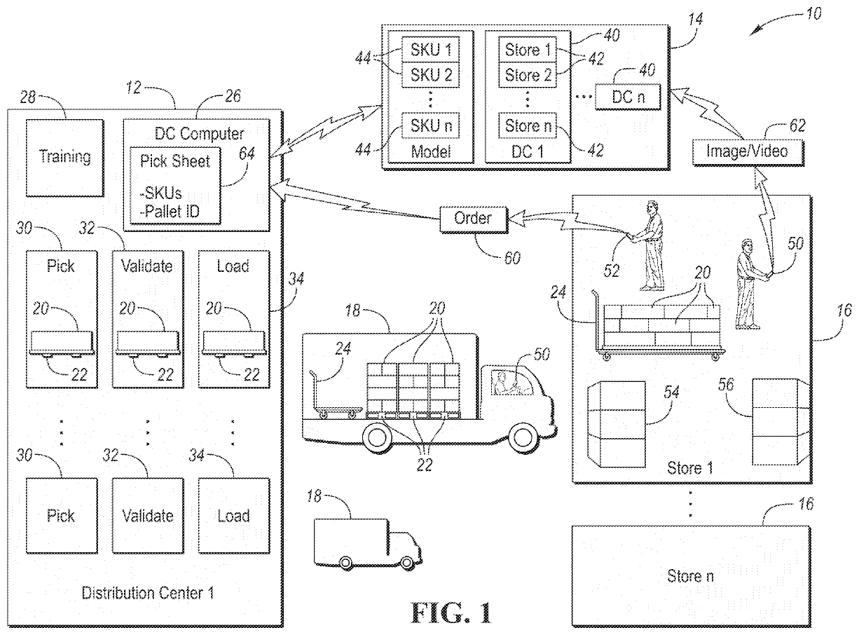

FIG. 1 is a high-level view of a delivery system 10 including one or more distribution centers 12, a central server 14 (e.g. cloud computer), and a plurality of stores 16. A plurality of trucks 18 or other delivery vehicles each transport the products 20 on pallets 22 from one of the distribution centers 12 to a plurality of stores 16. Each truck 18 carries a plurality of pallets 22 which may be half pallets (or full-size pallets), each loaded with a plurality of goods 20 for delivery to one of the stores 16. A wheeled sled 24 is on each truck 18 to facilitate delivery of one of more pallets 22 of goods 20 to each store 16. Generally, the goods 20 could be loaded on the half pallets, full-size pallets, carts, or hand carts, or dollies—all considered “platforms” herein.

Each distribution center 12 includes one or more pick stations 30, a plurality of validation stations 32, and a plurality of loading stations 34. Each loading station 34 may be a loading dock for loading the trucks 18.

Each distribution center 12 may include a DC computer 26. The DC computer 26 receives orders 60 from the stores 16 and communicates with a central server 14. Each DC computer 26 receives orders and generates pick sheets 64, each of which stores SKUs and associates them with pallet ids. Alternatively, the orders 60 can be sent from the DC computer 26 to the central server 14 for generation of the pick sheets 64, which are synced back to the DC computer 26.

Some or all of the distribution centers 12 may include a training station 28 for generating image information and other information about new products 20 which can be transmitted to the central server 14 for analysis and future use.

The central server 14 may include a plurality of distribution center accounts 40, including DC1-DCn, each associated with a distribution center 12. Each DC account 40 includes a plurality of store accounts 42, including store 1-store n. The orders 60 and pick sheets 64 for each store are associated the associated store account 42. The central server 14 further includes a plurality of machine learning models 44 trained as will be described herein based upon SKUs. The models 44 may be periodically synced to the DC computers 26 or may be operated on the server 14.

The machine learning models 44 are used to identify SKUs. A “SKU” may be a single variation of a product that is available from the distribution center 12 and can be delivered to one of the stores 16. For example, each SKU may be associated with a particular package type, e.g. the number of containers (e.g. 12 pack) in a particular form (e.g. can v bottle) and of a particular size (e.g. 24 ounces) optionally with a particular secondary container (cardboard vs reusable plastic crate, cardboard tray with plastic overwrap, etc). In other words, the package type may include both primary packaging (can, bottle, etc, in direct contact with the beverage or other product) and any secondary packaging (crate, tray, cardboard box, etc, containing a plurality of primary packaging containers).

Each SKU may also be associated with a particular “brand” (e.g. the manufacturer and the specific variation, e.g. flavor). The “brand” may also be considered the specific content of the primary package and secondary package (if any) for which there is a package type. This information is stored by the server 14 and associated with the SKU along with the name of the product, a description of the product, dimensions of the product, and optionally the weight of the product. This SKU information is associated with image information for that SKU in the machine learning models 44.

It is also possible that more than one variation of a product may share a single SKU, such as where only the packaging, aesthetics, and outward appearance of the product varies, but the content and quantity/size is the same. For example, sometimes promotional packaging may be utilized, which would have different image information for a particular SKU, but it is the same beverage in the same primary packaging with secondary packaging having different colors, text, and/or images. Alternatively, the primary packaging may also be different (but may not be visible, depending on the secondary packaging). In general, all the machine learning models 44 may be generated based upon image information generated through the training module 28.

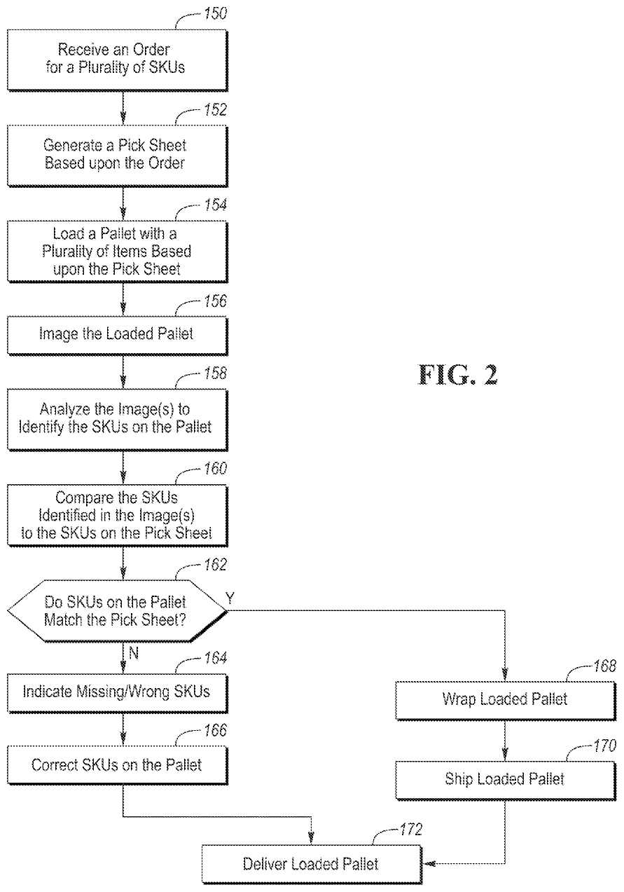

Referring to FIG. 1 and also to the flowchart in FIG. 2, an order 60 may be received from a store 16 in step 150. As an example, an order 60 may be placed by a store employee using an app or mobile device 52. The order 60 is sent to the distribution center computer 26 (or alternatively to the server 14, and then relayed to the proper (e.g. closest) distribution center computer 26). The distribution center computer 26 analyzes the order 60 and creates a pick sheet 64 associated with that order 60 in step 152. The pick sheet 64 assigns each of the SKUs (including the quantity of each SKU) from the order. The pick sheet 64 specifies how many pallets 22 will be necessary for that order (as determined by the DC computer 26). The DC computer 26 may also determine which SKUs should be loaded near one another on the same pallet 22, or if more than one pallet 22 will be required, which SKUs should be loaded together on the same pallet 22. For example, SKUs that go in the cooler may be together on the same pallet (or near one another on the same pallet), while SKUs that go on the shelf may be on another part of the pallet (or on another pallet, if there is more than one). If the pick sheet 64 is created on the DC computer 26, it is copied to the server 14. If it is created on the server 14, it is copied to the DC computer 26.

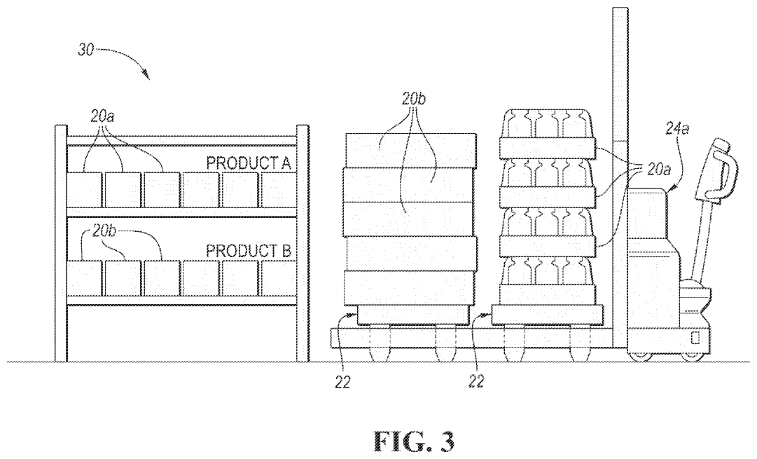

FIG. 3 shows one example of the pick station 30 of FIG. 1. Referring to FIGS. 1 and 3, workers at the distribution center read the palled id (e.g. via rfid, barcode, etc) on the pallet(s) 22 on a pallet jack 24a, such as with a mobile device or a reader on the pallet jack 24a. In FIG. 3, two pallets 22 are on a single pallet jack 24a. Shelves may contain a variety of items 20 for each SKU, such as first product 20a of a first SKU and a second product 20b of a second SKU (collectively “products 20”). A worker reading a computer screen or mobile device screen displaying from the pick sheet 64 retrieves each product 20 and places that product 20 on the pallet 22. Alternatively, the pallet 22 may be loaded by automated handling equipment.

Workers place items 20 on the pallets 22 according to the pick sheets 64, and report the palled ids to the DC computer 26 in step 154 (FIG. 2). The DC computer 26 dictates merchandizing groups and sub groups for loading items 20a, b on the pallets 22 in order to make unloading easier at the store. In the example shown, the pick sheets 64 dictate that products 20a are on one pallet 22 while products 20b are on another pallet 22. For example, cooler items should be grouped, and dry items should be grouped. Splitting of package groups is also minimized to make unloading easer. This makes pallets 22 more stable too.

The DC computer 26 records the pallet ids of the pallet(s) 22 that have been loaded with particular SKUs for each pick sheet 64. The pick sheet 64 may associate each pallet id with each SKU.

After being loaded, each loaded pallet 22 is validated at the validation station 32, which may be adjacent to or part of the pick station 30. As will be described in more detail below, at least one still image, and preferably several still images or video, of the products 20 on the pallet 22 is taken at the validation station 32 in step 156 (FIG. 2). The pallet id of the pallet 22 is also read. The images are analyzed to determine the SKUS of the products 20 that are currently on the identified pallet 22 in step 158. The SKUs of the products 20 on the pallet 22 are compared to the pick sheet 64 by the DC computer 26 in step 160, to ensure that all the SKUs associated with the pallet id of the pallet 22 on the pick sheet 64 are present on the correct pallet 22, and that no additional SKUs are present. Several ways are of performing the aforementioned steps are disclosed below.

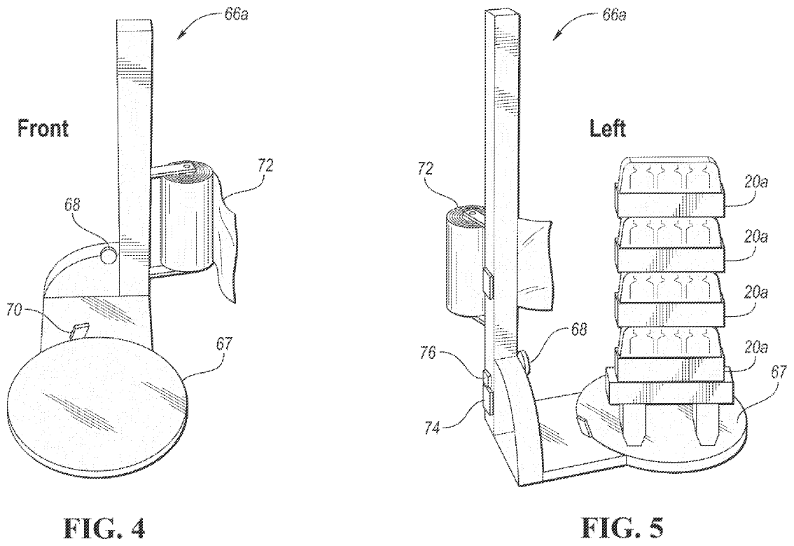

First, referring to FIGS. 4 and 5, the validation station may include a CV/RFID semi-automated wrapper 66a with turntable 67 that is fitted with a camera 68 and rfid reader 70 (and/or barcode reader). The wrapper 66a holds a roll of translucent, flexible, plastic wrap or stretch wrap 72. As is known, a loaded pallet 22 can be placed on the turntable 67, which rotates the loaded pallet 22 as stretch wrap 72 is applied. The camera 68 may be a depth camera. In this wrapper 66a, the camera 68 takes at least one image of the loaded pallet 22 while the turntable 67 is rotating the loaded pallet 22, prior to or while wrapping the stretch wrap 72 around the loaded pallet 22. Images/video of the loaded pallet 22 after wrapping may also be generated. As used herein, “image” or “images” refers broadly to any combination of still images and/or video, and “imaging” means capturing any combination of still images and/or video. Again, preferably 2 to 4 still images, or video, are taken. Most preferably, one still image of each of the four sides of a loaded pallet 22 is taken.

In one implementation, the camera 68 may be continuously determining depth while the turntable 67 is rotating. When the camera 68 detects that the two outer ends of the pallet 22 are equidistant (or otherwise that the side of the pallet 22 facing the camera 68 is perpendicular to the camera 68 view), the camera 68 records a still image. The camera 68 can record four still images in this manner, one of each side of the pallet 22.

The rfid reader 70 (or barcode reader, or the like) reads the pallet id (a unique serial number) from the pallet 22. The wrapper 66a includes a local computer 74 in communication with the camera 68 and rfid reader 70. The computer 74 can communicate with the DC computer 26 (and/or server 14) via a wireless network card 76. The image(s) and the pallet id are sent to the server 14 via the network card 76 and associated with the pick list 64 (FIG. 1). Optionally, a weight sensor can be added to the turntable 67 and the known total weight of the products 20 and pallet 22 can be compared to the measured weight on the turntable 67 for confirmation. An alert is generated if the total weight on the turntable 67 does not match the expected weight (i.e. the total weight of the pallet plus the known weights for the SKUs for that pallet id on the pick sheet). Other examples using the weight sensor are provided below.

As an alternative, the turntable 67, camera 68, rfid reader 70, and computer 74 of FIGS. 3 and 4 can be used without the wrapper. The loaded pallet 22 can be placed on the turntable 67 for validation only and can be subsequently wrapped either manually or at another station.

Alternatively, the validation station can include the camera 68 and rfid reader 70 (or barcode reader, or the like) mounted to a robo wrapper (not shown). As is known, instead of holding the stretch wrap 72 stationary and rotating the pallet 22, the robo wrapper travels around the loaded pallet 22 with the stretch wrap 72 to wrap the loaded pallet 22. The robo wrapper carries the camera, 68, rfid reader 70, computer 74 and wireless network card 76.

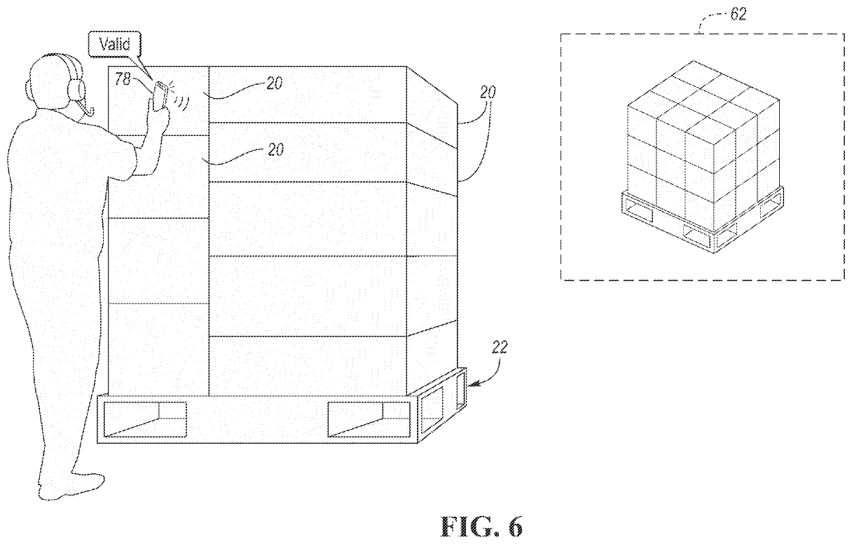

Alternatively, referring to FIG. 6, the validation station can include a worker with a networked camera, such as on a mobile device 78 (e.g. smartphone or tablet) for taking one or more images 62 of the loaded pallet 22, prior to wrapping the loaded pallet 22. Again, preferably, one image of each face of the loaded pallet 22 is taken. Note that FIG. 6 shows a full-size pallet (e.g. 40×48 inches). Any imaging method can be used with any pallet size, but a full-size pallet is shown in FIG. 6 to emphasize that the inventions herein (including the turntables and/or wrappers of FIGS. 3 and 4) can also be used with full-size pallets, although with some modifications.

Other ways can be used to gather images of the loaded pallet. In any of the methods, the image analysis and/or comparison to the pick list is performed on the DC computer 26, which has a copy of the machine learning models. Alternatively, the analysis and comparison can be done on the server 14, locally on a computer 74, or on the mobile device 78, or on another locally networked computer.

As mentioned above, the camera 68 (or the camera on the mobile device 78) can be a depth camera, i.e. it also provides distance information correlated to the image (e.g. pixel-by-pixel distance information or distance information for regions of pixels). Depth cameras are known and utilize various technologies such as stereo vision (i.e. two cameras) or more than two cameras, time-of-flight, or lasers, etc. If a depth camera is used, then the edges of the products stacked on the pallet 22 are easily detected (i.e. the edges of the entire stack and possibly edges of individual adjacent products either by detecting a slight gap or difference in adjacent angled surfaces). Also, the depth camera 68 can more easily detect when the loaded pallet 22 is presenting a perpendicular face to the view of the camera 68 for a still image to be taken.

However the image(s) of the loaded pallet 22 are collected, the image(s) are then analyzed to determine the sku of every item 20 on the pallet 22 in step 158 (FIG. 2). Image information, weight and dimensions of all sides of every possible product, including multiple versions of each SKU, if applicable, are stored in the server 14.

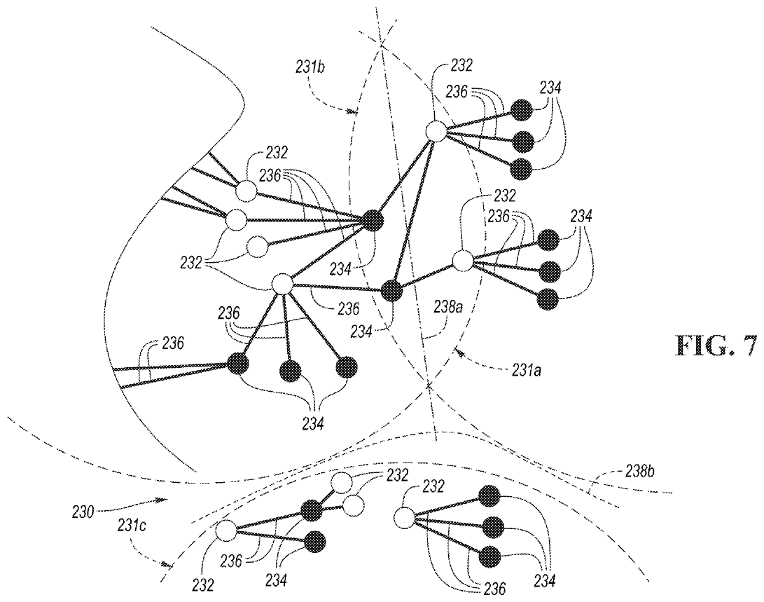

FIG. 7 shows a portion of a brand model map 230 containing the machine learning models for the brand identification, in this example brand models 231a, 231b, 231c. In FIG. 7, each white node is a brand node 232 that represents a particular brand and each black node is a package node 234 that represents a package type. Each edge or link 236 connects a brand node 232 to a package node 234, such that each link 236 represents a SKU. Each brand node 232 may be connected to one or more package nodes 234 and each package node 234 may connect to one or more brand nodes 232.

In practice, there may be hundreds or thousands of such SKUs and there would likely be two to five models 231. If there are even more SKUs, there could be more models 231. FIG. 7 is a simplified representation showing only a portion of each brand model 231a, 231b, 231c. Each model may have dozens or even hundreds of SKUs.

Within each of models 231a and 231b, all of the brand nodes 232 and package nodes 234 are connected in the graph, but this is not required. In fact, there may be one or more (four are shown) SKUs that are in both models 231a and 231b. There is a cut-line 238a separating the two models 231a and 231b. The cut-line 238a is positioned so that it cuts through as few SKUs as possible but also with an aim toward having a generally equal or similar number of SKUs in each model 231. Each brand node 232 and each package node 234 of the SKUs along the cut-line 238a are duplicated in both adjacent models 231a and 231b. For the separation of model 231c from models 231a and 231b, it was not necessary for the cut line 238b to pass through (or duplicate) any of the SKUs or nodes 232, 234.

In this manner, the models 231a and 231b both learn from the SKUs along the cut 238b. The model 231b learns more about the brand nodes 232 in the overlapping region because it also learns from those SKUs. The model 231a learns more about the package types 234 in the overlapping region because it also learns from those SKUs. If those SKUs were only placed in one of the models 231a, 231b, then the other model would not have as many samples from which to learn.

In brand model 231c, for example, as shown, there are a plurality of groupings of SKUs that do not connect to other SKUs, i.e. they do not share either a brand or a package type. The model 231c may have many (dozens or more) of such non-interconnected groupings of SKUs. The model 231a and the model 231b may also have some non-interconnected groupings of SKUs (not shown).

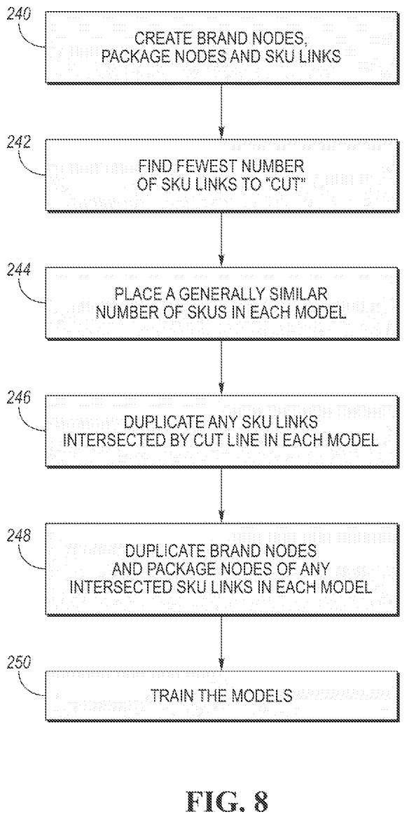

Referring to FIGS. 7 and 8, the process for creating the models 231 is automated and performed in the central server 14 or the DC computer 26 (FIG. 1). In particular, this is the process for creating the brand models. There would be one model for determining package type and then depending on how many brands there are, the SKUs are separated into multiple separate machine learning models for the brands.

This process is performed initially when creating the machine learning models and again when new SKUs are added. Initially, a target number of SKUs per model or a target number of models may be chosen to determine a target model size. Then the largest subgraph (i.e. a subset of SKUs that are all interconnected) is compared to the target model size. If the largest subgraph is within a threshold of the target model size, then no cuts need to be made. If the largest subgraph is more than a threshold larger than the target model size, then the largest subgraph will be cut according to the following method. In step 240, the brand nodes 232, package nodes 234, and SKU links 236 are created. In steps 242 and 244, the cut line 238 is determined as the fewest numbers of SKU links 236 to cut (cross), while placing a generally similar number of SKUs in each model 231. The balance between these two factors may be adjusted by a user, depending on the total number of SKUs, for example. In step 246, any SKU links 236 intersected by the “cut” are duplicated in each model 231. In step 248, the brand nodes 232 and package nodes 234 connected to any intersected SKU links 236 are also duplicated in each model 231. In step 250, the models 231 a, b, c are then trained according to one of the methods described herein, such as with actual photos of the SKUs and/or with the virtual pallets.

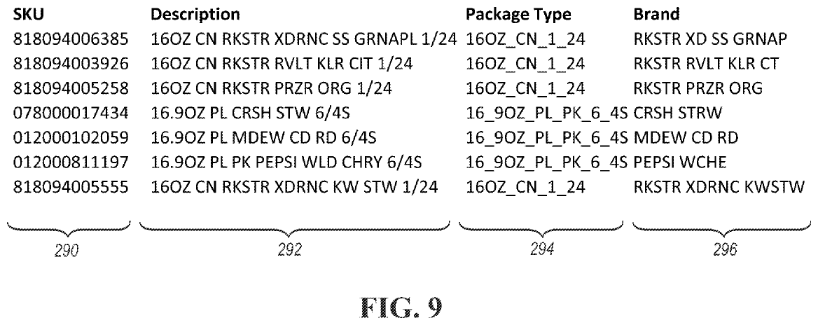

Referring to FIG. 9, each SKU 290 is also associated with a text description 292, a package type 294 and a brand 296. Each package type 294 corresponds to one of the package nodes 234 of FIG. 7, and each brand 296 corresponds to one of the brand nodes 232 of FIG. 7. Therefore, again, each package type 294 may be associated with more than one brand 296, and each brand 296 may be available in more than one package type 294. The package type 294 describes the packaging of the SKU 290. For example 160Z_CN_1_24 is a package type 294 to describe sixteen ounce cans with twenty-four grouped together in one case. A case represents the sellable unit that a store can purchase from the manufacturer. The brand 296 is the flavor of the beverage and is marketed separately for each flavor. For example, Pepsi, Pepsi Wild Cherry and Mountain Dew are all “brands.” Each flavor of Gatorade is a different “brand.”

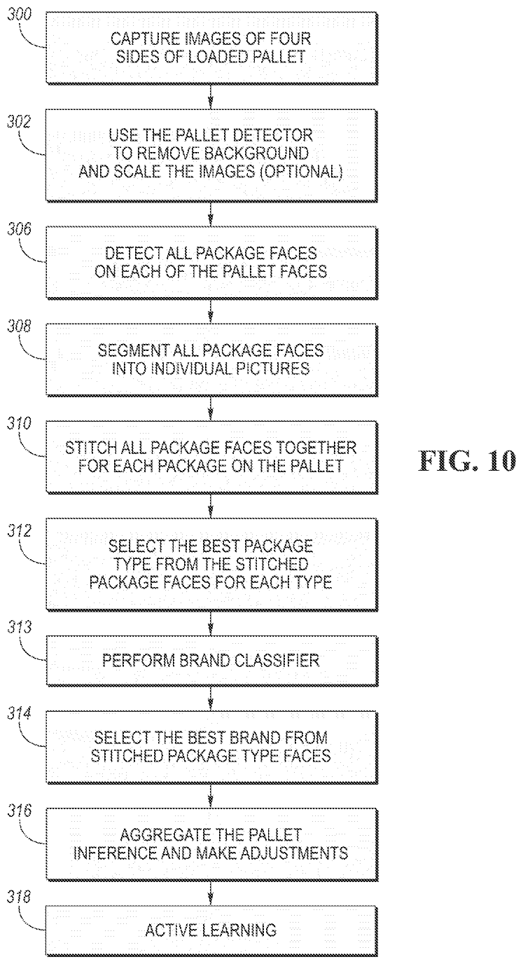

FIG. 10 shows an example of one method for identifying skus on the loaded pallet 22. In step 300, images of four sides of the loaded pallet 22 are captured according to any method, such as those described above.

FIG. 10 depicts optional step 302, in which the pallet detector module is used to remove the background and to scale the images. The pallet detector uses a machine learning object detector model that detects all of the products on the pallet 22 as a single object. The model is trained using the same virtual pallets and real pallet images that also used for the package detector but labeled differently. The pallet detector is run against each of the four images of the pallet faces. The background is blacked out so that product not on the pallet 22 is hidden from the package detector inference run later. This prevents mistakenly including skus that are not on the pallet. The left and right pallet faces are closer to the camera than the front and back faces. This causes the packages on the left and right face to look bigger than the packages on the front and back faces. The pallet detector centers and scales the images so that the maximum amount of product is fed to the pallet detector model. Again this step of blacking out the background and scaling the images is optional.

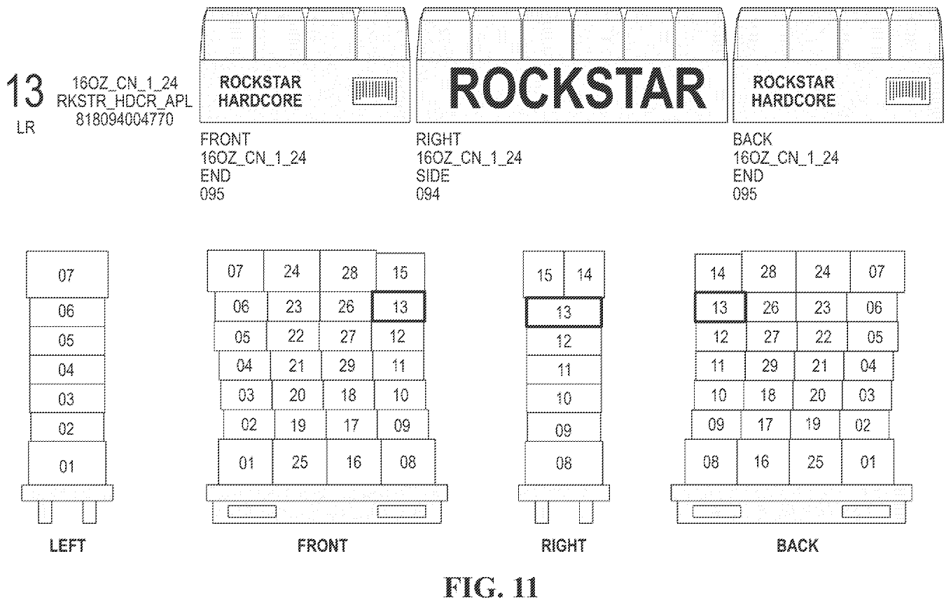

Referring to FIGS. 10 and 11, in step 306, a machine learning object detector detects all the package faces on the four pallet faces. The package type is independent from the brand. Package types are rectangular in shape. The long sides are called “SIDE” package faces and the short sides are called “END” package faces. In step 308, all package faces are segmented into individual pictures as shown in FIG. 11, so that the brand can be classified separately from package type. This is repeated for all four pallet faces.

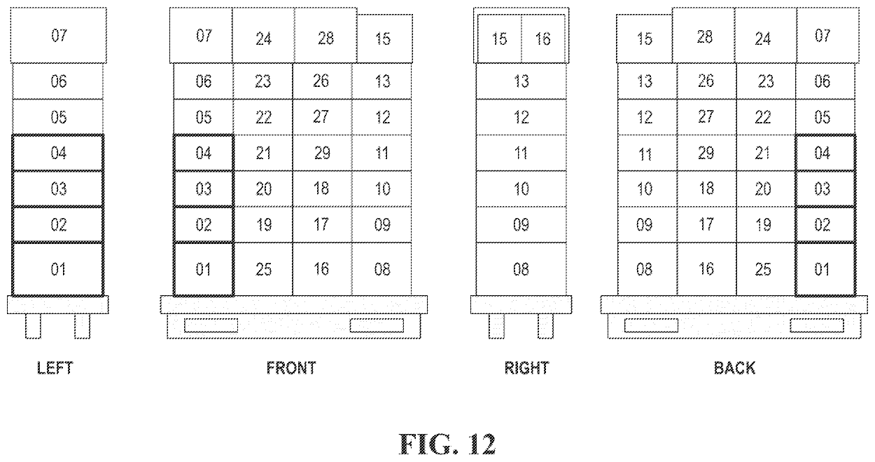

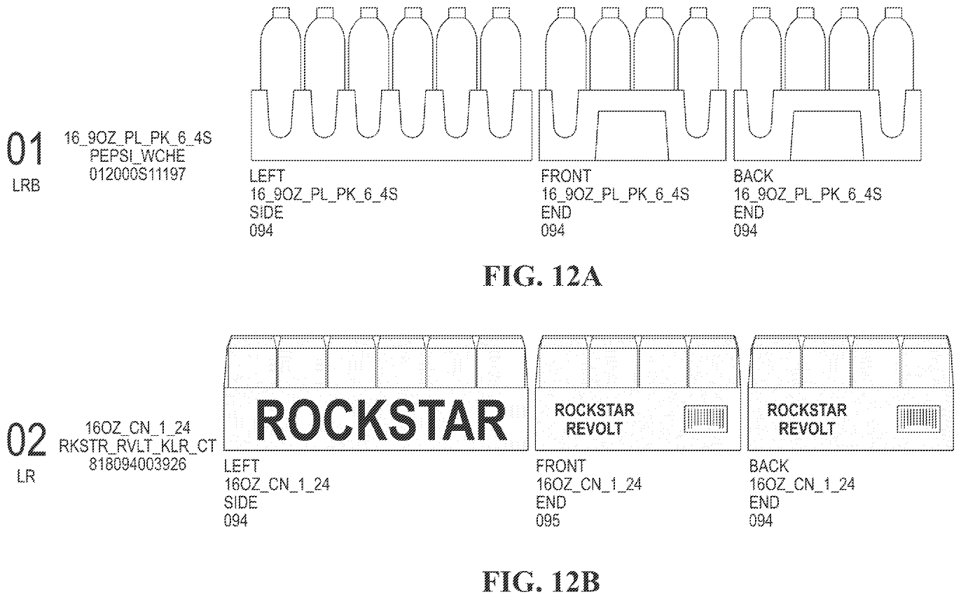

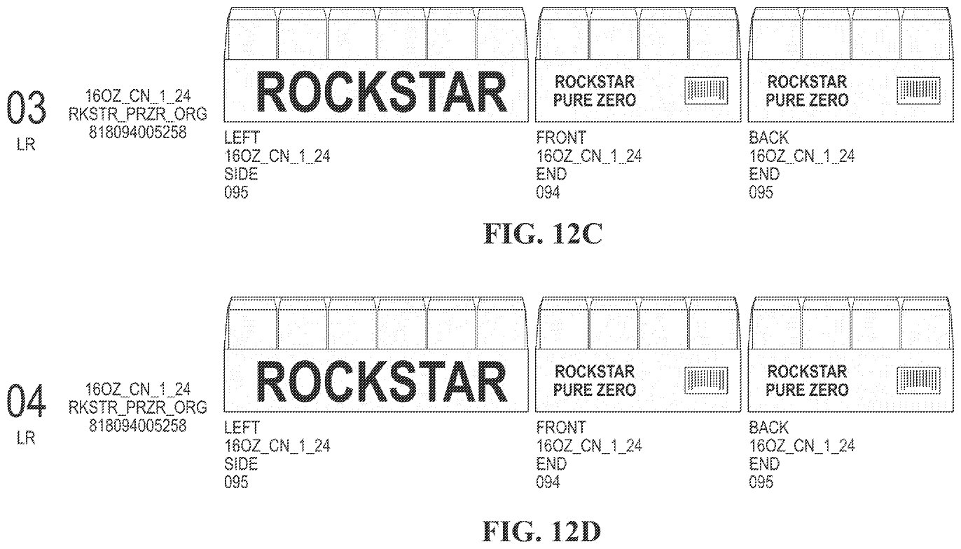

Referring to FIGS. 10 and 12, in step 310, it is determined which package face images belong to the same package through stitching. In this sense, “stitching” means that the images of the same item are associated with one another and with a particular item location on the pallet. Some packages are only visible on one pallet face and only have one image. Packages may have zero to four package faces visible. Packages that are visible on all four pallet faces will have four package face images stitched together. In FIG. 12, the package faces that correspond to the same package are numbered the same.

FIG. 12A shows the three package faces for product 01 from FIG. 12. FIG. 12B shows the three package faces for product 02 from FIG. 12. FIG. 12C shows the three package faces for produce 03 from FIG. 12. FIG. 12D shows the three package faces for product 04 from FIG. 12.

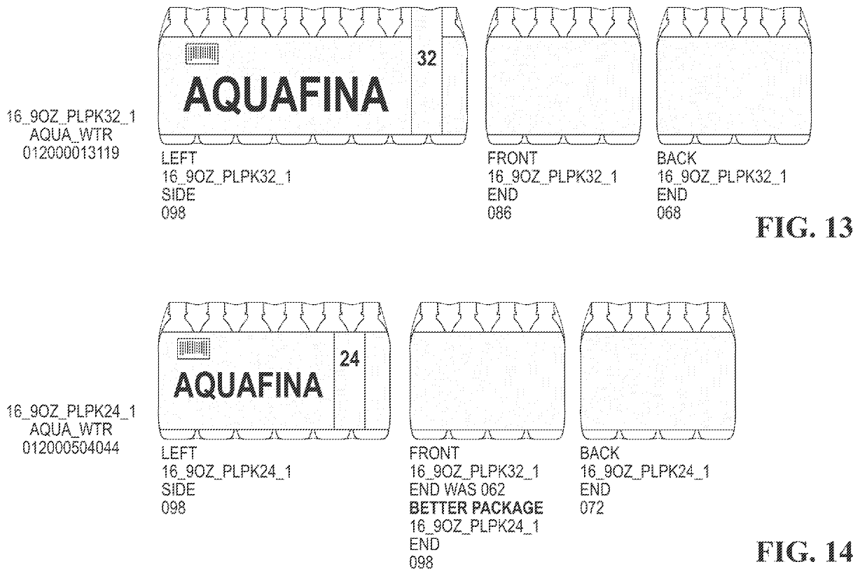

Referring to FIGS. 10, 13, and 14 in step 312, the package type of each product is inferred for each of the (up to four) possible package faces, using a machine learning model for determining package type. The package type machine learning model infers at least one package type based upon each package face independently and generates an associated confidence level for that determined package type for that package face. The package type machine learning module may infer a plurality of package types (e.g. five to twenty) based upon each package face with a corresponding confidence level associated with each such inferred package type. In FIGS. 13 and 14, only the highest-confidence package type for each package face is shown.

For each item (i.e. the images stitched together), the package face(s) with lower confident package types are overridden with the highest confident package type out of the package face images for that item. The package type with the highest confidence out of all the package face images for that item is used to override any different package type of the rest of the package faces for that same item.

For the two examples shown in FIGS. 13 and 14, the package face end views may look the same for two SKUs so it is very hard to distinguish the package type from the end views; however, the package face side view is longer for the 32 pack than the 24 pack plus the respective 32 and 24 count is visible on the package and the machine learning module can easily distinguish the difference on the side view between the 24 and 32 pack from the long side view. For example in FIG. 14, the package end face view with a confidence of 62% was overridden by a higher confidence side view image of 98% to give a better package type accuracy. Other package types include reusable beverage crate with certain bottle sizes or can sizes, corrugated tray with translucent plastic wrap a certain bottle or can sizes, or fully enclosed cardboard or paperboard box. Again, “package type” may include a combination of the primary and secondary packaging.

In step 313 of FIG. 10, for each package face, a brand model (e.g. brand models 231a, b, or c of FIG. 7) is loaded based upon the package type that was determined in step 312 (i.e. after the lower-confidence package types have been overridden). Some brands are only in their own package types. For example, Gatorade is sold in around a dozen package types but those package types are unique to Gatorade and other Pepsi products are not packaged that way. If it is determined that the package faces of a package have a Gatorade package type then those images are classified using the Gatorade brand model (for example, brand model 231c of FIG. 7). Currently, the brand model for Gatorade contains over forty flavors that can be classified. It is much more accurate to classify a brand from forty brands than to classify a brand from many hundreds or more than a thousand of brands, which is why the possibilities are first limited by the inferred package type.

The machine learning model (e.g. models 231a, b, or c of FIG. 7) that has been loaded based upon package type infers a brand independently for each package face of the item and associates a confidence level with that inferred brand for each package face. Initially, at least, higher-confidence inferred brands are used to override lower-confidence inferred brands of other package faces for the same item.

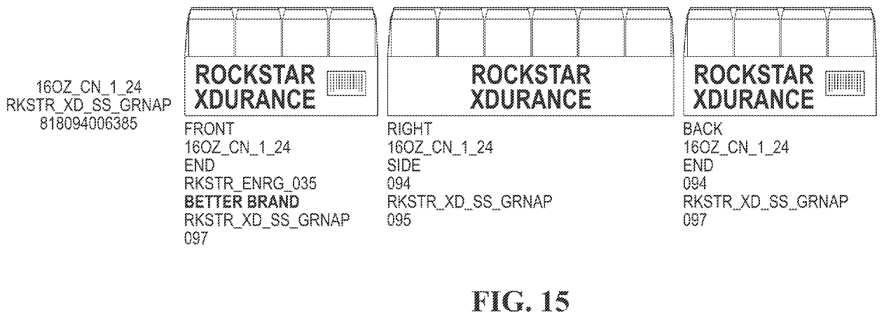

Referring to FIG. 15, one example was stitched to have the 160Z_CN_1_24 package type. The package was visible on three package faces. Based upon the package type model, the inference constantly agreed on this package type on all three faces. The best machine learning model 231a, b or c for brand was loaded based on the package type. If stitching would have overridden a package type for one or more package faces, then the same brand model 231a, b or c would still be used for all of the segmented images based upon the best package type out of all of the segmented images.

The example shown in FIG. 15 shows that the machine learning algorithm first classified the front image to be RKSTR_ENRG with a low 35% confidence. Fortunately, the back image had a 97% confidence of the real brand of RKSTR_XD_SS_GRNAP and the brand on the front image was overridden. At least initially, and except as otherwise described below, the best brand (i.e. highest confidence brand) from all of the stitched package images is used to determine the brand for that item. Having determined all of the package types and then the brands for each item on the pallet, the SKU for each item is determined in step 314 (FIG. 10).

It should be noted that some product is sold to stores in groups of loose packages. All of the packages are counted and divided by the number of packages sold in a case to get the inferred case quantity. The case quantity is the quantity that stores are used to dealing with on orders.

The pick list that has the expected results is then leveraged to the actual inferred results. There should be high confidence that there is an error before reporting the error so there are not too many false errors. The known results of the pick list can be leveraged to make corrections to the inferred results so that too many false errors are not reported

The number of false errors reported may be reduced by comparison to weight. The weight of the actual loaded pallet is particularly useful for removing false inferred counts like seeing the tops of the package as an extra count or detecting product beside the pallet in the background that is not part of the pallet.

If the actual weight is close to the expected weight then the pallet is likely to be picked correctly. If the inferred weight is then out of alignment with the expected weight while the actual weight from the scale is in alignment, then the inference likely has a false error.

In step 318 of FIG. 10, the system can learn from itself and improve over time unsupervised without human help through active learning. Often time, errors are automatically corrected through stitching. If the pallet inference generates the expected results as compared to the pick list SKUs and quantities then it is very likely that the correct product is on the pallet. The pallet face images can be labeled for machine learning training based on the object detector results and brand classification results and stitching algorithm corrections.

After individual items 20 are identified on each of the four sides of the loaded pallet 22, based upon the known dimensions of the items 20 and pallet 22 duplicates are removed, i.e. it is determined which items are visible from more than one side and appear in more than one image. If some items are identified with less confidence from one side, but appear in another image where they are identified with more confidence, the identification with more confidence is used.

For example, if the pallet 22 is a half pallet, its dimensions would be approximately 40 to approximately 48 inches by approximately 20 to approximately 24 inches, including the metric 800 mm×600 mm Standard size beverage crates, beverage cartons, and wrapped corrugated trays would all be visible from at least one side, most would be visible from at least two sides, and some would be visible on three sides.

If the pallet 22 is a full-size pallet (e.g. approximately 48 inches by approximately 40 inches, or 800 mm by 1200 mm), most products would be visible from one or two sides, but there may be some products that are not visible from any of the sides. The dimensions and weight of the hidden products can be determined as a rough comparison against the pick list. Optionally, stored images (from the SKU files) of SKUs not matched with visible products can be displayed to the user, who could verify the presence of the hidden products manually.

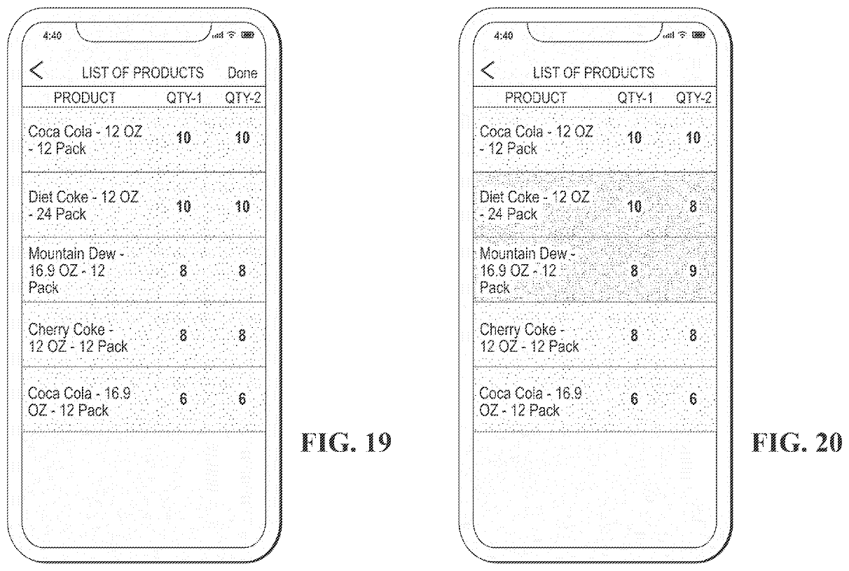

The computer vision-generated sku count for that specific pallet 22 is compared against the pick list 64 to ensure the pallet 22 is built correctly in step 162 of FIG. 2. This may be done prior to the loaded pallet 22 being wrapped thus preventing unwrapping of the pallet 22 to audit and correct. If the built pallet 22 does not match the pick list 64 (step 162), the missing or wrong SKUs are indicated to the worker (step 164), e.g. via a display (e.g. FIG. 19). Then the worker can correct the items 20 on the pallet 22 (step 166) and reinitiate the validation (i.e. initiate new images in step 156).

If the loaded pallet 22 is confirmed, positive feedback is given to the worker (e.g. FIG. 20), who then continues wrapping the loaded pallet 22 (step 168). Additional images may be taken of the loaded pallet 22 after wrapping. For example, four image may be taken of the loaded pallet before wrapping, and four more images of the loaded pallet 22 may be taken after wrapping. All images are stored locally and sent to the server 14. The worker then moves the validated loaded pallet 22 to the loading station 34 (step 170)

After the loaded pallet 22 has been validated, it is moved to a loading station 34 (FIG. 1). At the loading station 34, the distribution center computer 26 ensures that the loaded pallets 22, as identified by each pallet id, are loaded onto the correct trucks 18 in the correct order. For example, pallets 22 that are to be delivered at the end of the route are loaded first.

Referring to FIG. 1, the loaded truck 18 carries a hand truck or pallet sled 24, for moving the loaded pallets 22 off of the truck 18 and into the stores 16 (FIG. 2, step 172). The driver has a mobile device 50 which receives an optimized route from the distribution center computer 26 or central server 14. The driver follows the route to each of the plurality of stores 16 for which the truck 18 contains loaded pallets 22.

At each store 16 the driver's mobile device 50 indicates which of the loaded pallets 22 (based upon their pallet ids) are to be delivered to the store 16 (as verified by gps on the mobile device 50). The driver verifies the correct pallet(s) for that location with the mobile device 50 that checks the pallet id (rfid, barcode, etc). The driver moves the loaded pallet(s) 22 into the store 16 with the pallet sled 24.

At each store, the driver may optionally image the loaded pallets with the mobile device 50 and send the images to the central server 14 to perform an additional verification. More preferably, the store worker has gained trust in the overall system 10 and simply confirms that the loaded pallet 22 has been delivered to the store 16, without taking the time to go SKU by SKU and compare each to the list that he ordered and without any revalidation/imaging by the driver. In that way, the driver can immediately begin unloading the products 20 from the pallet 22 and placing them on shelves 54 or in coolers 56, as appropriate. This greatly reduces the time of delivery for the driver.

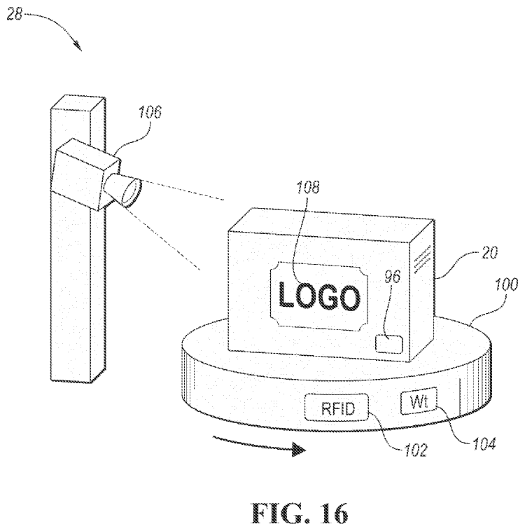

FIG. 16 shows a sample training station 28 including a turntable 100 onto which a new product 20 (e.g. for a new SKU or new variation of an existing SKU) can be placed to create the machine learning models 44. The turntable 100 may include an RFID reader 102 for reading an RFID tag 96 (if present) on the product 20 and a weight sensor 104 for determining the weight of the product 20. A camera 106 takes a plurality of still images and/or video of the packaging of the product 20, including any logos 108 or any other indicia on the packaging, as the product 20 is rotated on the turntable 100. Preferably all sides of the packaging are imaged. The images, weight, RFID information are sent to the server 14 to be stored in the SKU file on the server 14. Optionally, multiple images of the product 20 are taken at different angles and/or with different lighting. Alternatively, or additionally, the computer files with the artwork for the packaging for the product 20 (i.e. files from which the packaging is made) are sent directly to the server 14.

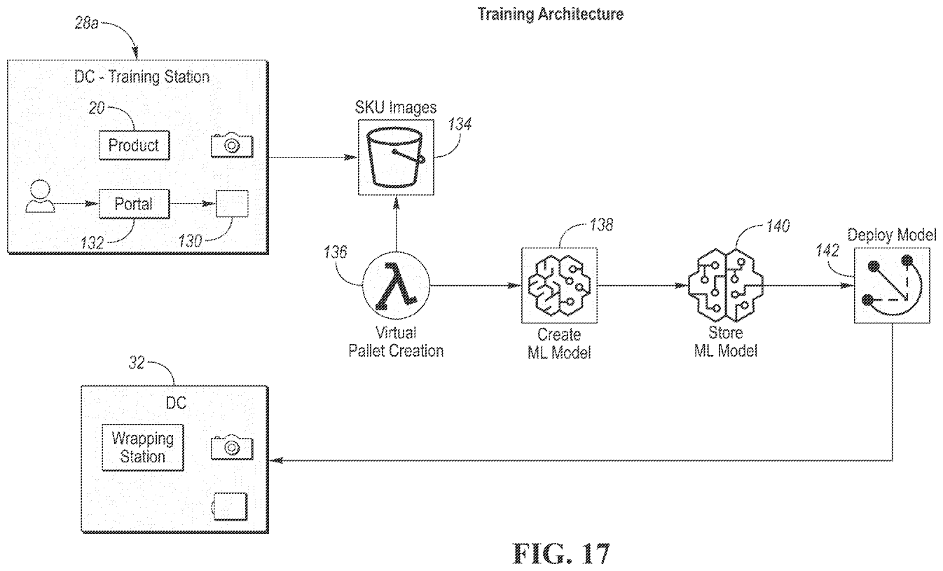

In one possible implementation of training station 28, shown in FIG. 17, cropped images of products 20 from the training station 28 are sent from the local computer 130 via a portal 132 to sku image storage 134, which may be at the server 14. Alternatively, or additionally, the computer files with the artwork for the packaging for the product 20 (i.e. files from which the packaging is made) are sent directly to the server 14. Alternatively, or additionally, actual images of the skus are taken and segmented (i.e. removing the background, leaving only the sku).

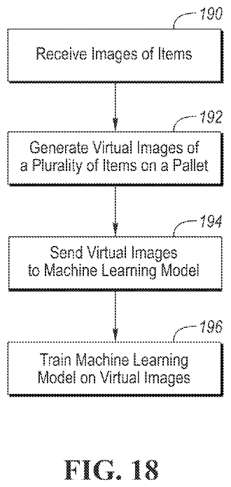

Whichever method is used to obtain the images of the items, the images of the items are received in step 190 of FIG. 18. In step 192, an API 136 takes the sku images and builds them into a plurality of virtual pallets, each of which shows how the products 20 would look on a pallet 22. The virtual pallets may include four or five layers of the product 20 on the pallet 22. Some of the virtual pallets may be made up solely of the single new product 20, and some of the virtual pallets will have a mixture of images of different products 20 on the pallet 22. The API 136 also automatically tags the locations and/or boundaries of the products 20 on the virtual pallet with the associated skus. The API creates multiple configurations of the virtual pallet to send to a machine learning model 138 in step 194 to update it with the new skus and pics.

The virtual pallets are built based upon a set of configurable rules, including, the dimensions of the pallet 22, the dimensions of the products 20, number of permitted layers (such as four, but it could be five or six), layer restrictions regarding which products can be on which layers (e.g. certain bottles can only be on the top layer), etc. The image of each virtual pallet is sized to be a constant size (or at least within a particular range) and placed on a virtual background, such as a warehouse scene. There may be a plurality of available virtual backgrounds from which to randomly select.

The API creates thousands of images of randomly-selected sku images on a virtual pallet. The API uses data augmentation to create even more unique images. Either a single loaded virtual pallet image can be augmented many different ways to create more unique images, or each randomly-loaded virtual pallet can have a random set of augmentations applied. For example, the API may add random blur (random amount of blur and/or random localization of blur) to a virtual pallet image. The API may additionally introduce random noise to the virtual pallet images, such as by adding randomly-located speckles of different colors over the images of the skus and virtual pallet. The API may additionally place the skus and virtual pallet in front of random backgrounds. The API may additionally place some of the skus at random (within reasonable limits) angles relative to one another both in the plane of the image and in perspective into the image. The API may additionally introduce random transparency (random amount of transparency and/or random localized transparency), such that the random background is partially visible through the virtual loaded pallet or portions thereof. Again, the augmentations of the loaded virtual pallets are used to generate even more virtual pallet images.

The thousands of virtual pallet images are sent to the machine learning model 138 along with the bounding boxes indicating the boundaries of each product on the image and the SKU associated with each product. The virtual pallet images along with the bounding boxes and associated SKUs constitute the training data for the machine learning models.

In step 196, the machine learning model 138 is trained based upon the images of the virtual pallets and based upon the location, boundary, and sku tag information. The machine learning model is updated and stored in step 140. The machine learning model is deployed in step 142 and used in conjunction with the validation stations 32 (FIG. 1) and optionally with the delivery methods described above. The machine learning model 138 may also be trained based upon actual images taken in the distribution center or the stores after identification. Optionally, feedback from the workers can factor into whether the images are used, e.g. the identified images are not used until a user has had an opportunity to verify or contradict the identification.

It should be understood that each of the computers, servers or mobile devices described herein includes at least one processor and at least one non-transitory computer-readable media storing instructions that, when executed by the at least one processor, cause the computer, server, or mobile device to perform the operations described herein. The precise location where any of the operations described herein takes place is not important and some of the operations may be distributed across several different physical or virtual servers at the same or different locations.

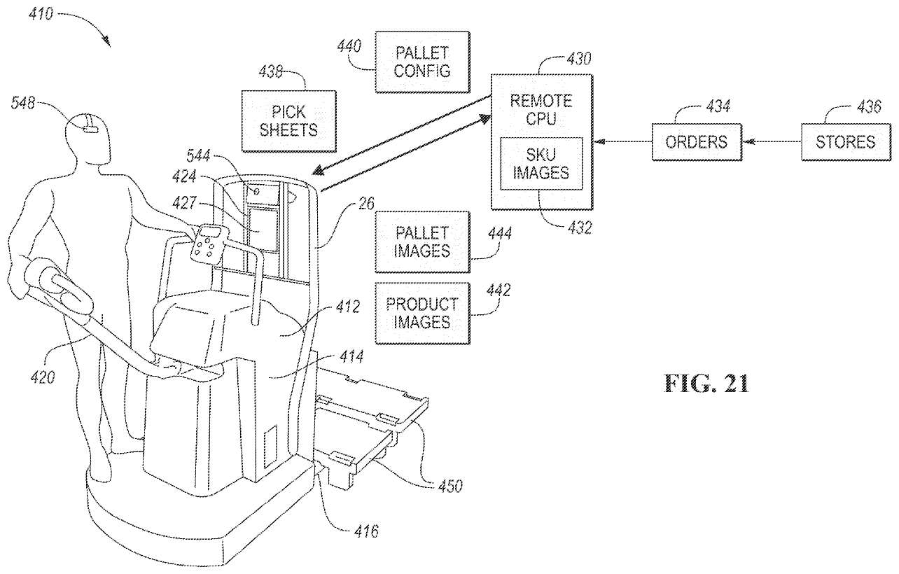

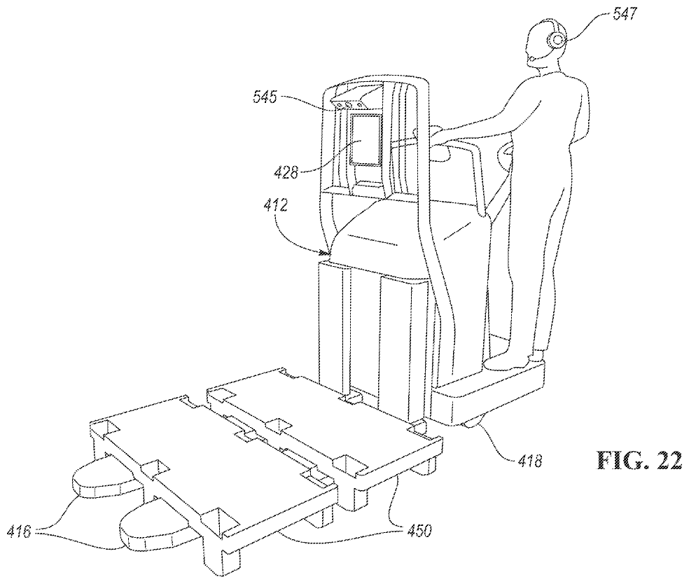

FIG. 21 shows one possible implementation of a pick system 410 including a pallet sled 412 having a base 414 and pair of tines 416 that are selectively raised and lowered relative to the base 414. Wheels 418 (FIG. 22) support the base 414 and tines 416 and may propel the pallet sled 412. A handle 420 is pivotably connected to the base 414 for controlling the pallet sled 412. The pallet sled 412 may use a standard pallet jack mechanism for raising the tines 416 relative to the floor, or any type of electrical, hydraulic or mechanical lift system.

As is known, the tines 416 are selectively raised and lowered relative to the floor to lift pallets 450 and transport them with the pallet sled 412. In the examples shown herein, two half-pallets 450 are carried on the tines 416, but full-size pallets could also be used. For example, the pallet sleds may carry a single full-size pallet instead of two half-pallets 450, but otherwise would operate the same. If two half-pallets 450 are carried by the pallet sled 412, they are both picked at the same time.

A mobile device 424, such as a tablet or smartphone (e.g. iPad or iPhone), is mounted to a frame 426 extending upward from the base 414. The mobile device 424 may be a commercially-available tablet or smartphone having at least one processor, electronic storage (for storing data and instructions), a first touchscreen 427 facing the user, at least one rear-facing camera 544, and multiple wireless communication modules (such as wi-fi, Bluetooth, cell data, NFC, etc). The mobile device 424 may also include circuitry (internally or as an external accessory) and programming for determining its location within the distribution center (e.g. relative to fiducials throughout the distribution center).

The pick system 410 includes a remote CPU 430, such as a server, cloud computer, cluster of computers, etc. The remote CPU 430 could be multiple computers performing different functions at different locations. The remote CPU 430, among other things, stores a plurality of images of each of a plurality of available SKUs. For example, the available SKUs in the example described herein are cases of beverage containers, such as cartons of cans, plastic beverage crates containing bottles or cans, cardboard trays with plastic overwrap containing bottles or cans, cardboard boxes of bottles or cans, etc. There are many different permutations of flavors, sizes, case types, and types of beverage containers that may each be a different SKU.

The remote CPU 430 is programmed to receive orders 434 from a plurality of stores 436. Each order 434 is a list of SKUs and a quantity of each SKU. As will be explained in more detail below, the mobile device 424 and the remote CPU 430 are programmed to communicate, including (in broad terms) the mobile device 424 receiving pick sheets 438 from the remote CPU 430. The pick sheets 438 each contain a list of SKUs that should be on the same pallet 450. Additionally, the remote CPU 430 may also send pallet configuration 440 files containing information indicating the location on each pallet 450 where each SKU should be placed, as will be explained further below. The remote CPU 430 also sends the SKU images 432 (images of what each SKU should look like, including at least one side, but preferably two or three or all sides of the SKU) to the mobile device 424.

The remote CPU 430 dictates merchandizing groups and sub groups for loading items 420 on the pallets 450 in order to make unloading easier at the store. For example, the pick sheets 438 may dictate that certain products 420 destined for one store are on one pallet 450 while other products 420 destined for the same store are on another pallet 450. The pick sheets 438 and pallet configurations 440 also specify arrangements of SKUs on each pallet 450 that group products efficiently and for a stable load on the pallet 450. For example, cooler items should be grouped, and dry items should be grouped. Splitting of package groups is also minimized to make unloading easer. This makes pallets 450 more stable too. The arrangement and location of the items 420 on the pallets 450 may be optimized by the remote CPU 430 to improve the stability of the loaded pallets 450. Eventually, each pick sheet 438 is associated with a pallet id, such that each SKU is associated with a particular palled id (and a particular pallet 450). Products 420 destined for different stores would be on different pallets 450, but more than one pallet 450 may be destined for one store.

As will be further explained, the mobile device 424 may send product images 442 (i.e. images of individual products being carried by a user) and pallet images 444 (images of loaded or partially loaded pallets) to the remote CPU 430. Alternatively, these images 442, 444 are processed locally on the mobile device 424.

Referring to FIG. 22, the mobile device 424 in this example also has a second touchscreen 428 (or an external, connected second touchscreen), facing the pallets 450. A headset 547 worn by the picker may relay audible instructions from the mobile device 424 to the picker and may relay voice commands from the picker to the mobile device 424, such as via Bluetooth.

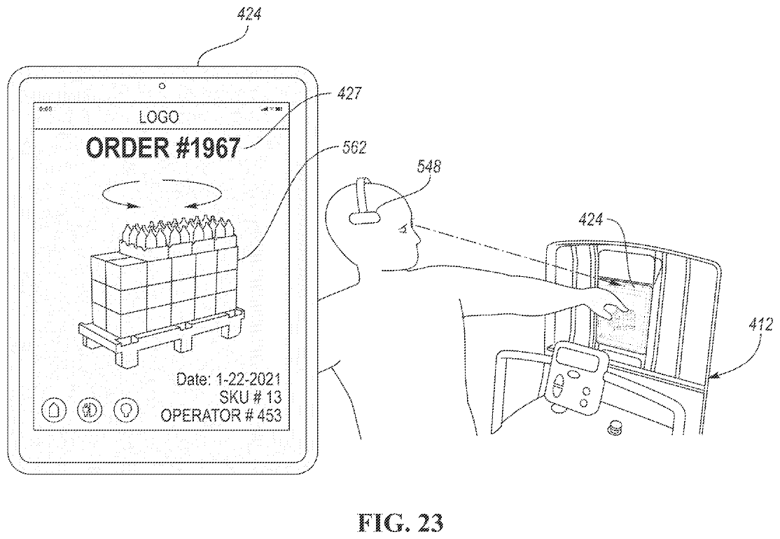

Referring to FIG. 23, the pick sheet 438, in this case for order number 1967, is sent to the mobile device 424 from the remote CPU 430 (FIG. 21). The remote CPU 430 also sends to the mobile device 424 SKU images 432 for every SKU on the pick sheet 438. This can happen along with every pick sheet 438 or the mobile device 424 can store all the SKU images 432 and periodically receive updates.

The mobile device 424 generates a 3D image 562 of what the final, loaded pallet 450 should look like, with all the products in the proper location according to the pallet configuration 440 from the remote CPU 430 and using the SKU images 432 from the remote CPU 430. The user can rotate and otherwise manipulate (e.g. removing layers) the 3D image 562 on the touchscreen 427 of the mobile device 424. The user can at any time prompt the mobile device 424 to display either final pallet 450 carried by the pallet sled 412.

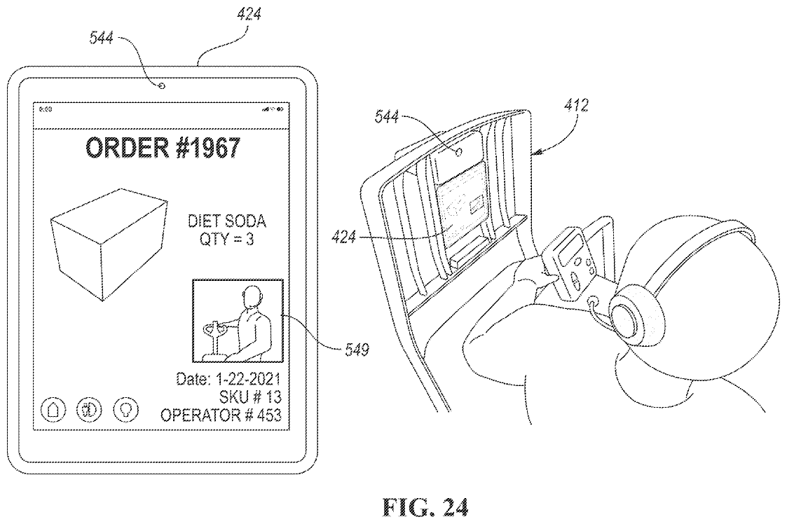

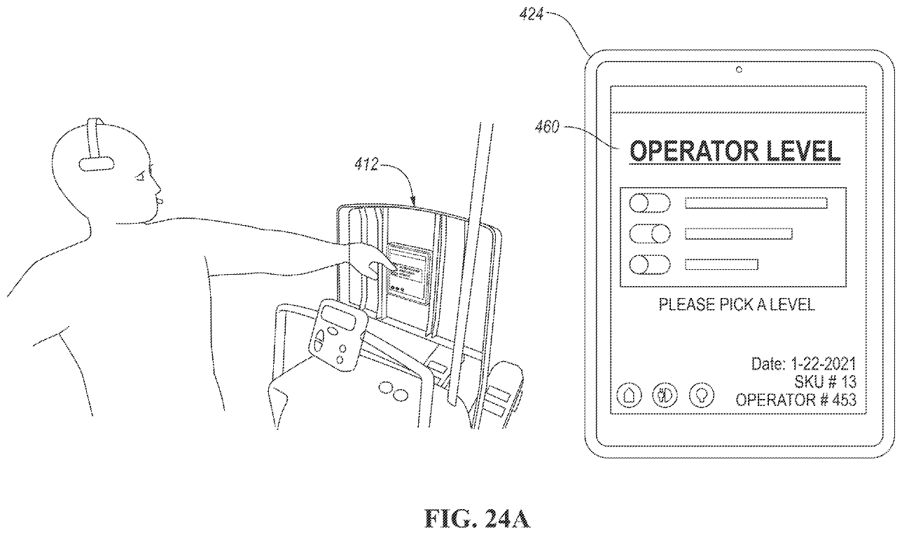

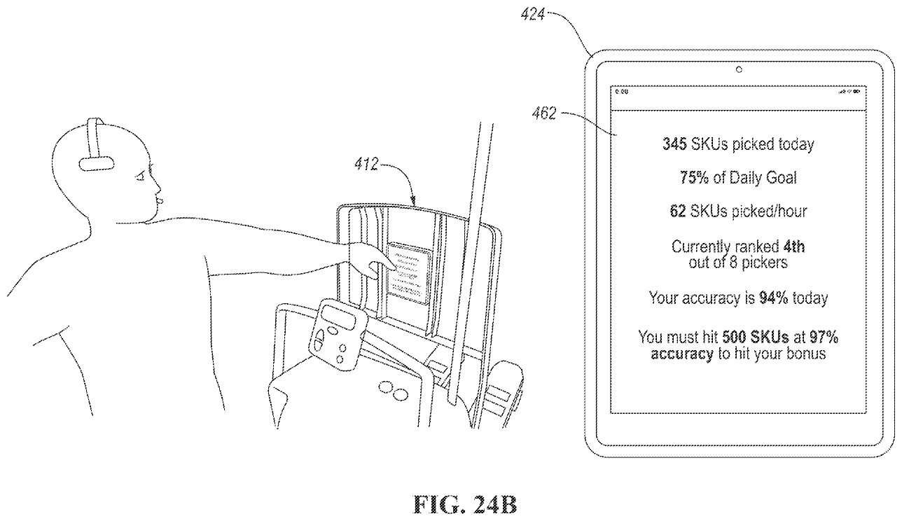

As shown in FIG. 24, a back-facing camera 544 on the mobile device 424 takes a picture 549 of the picker for accountability management for every pallet 450.

Referring to FIG. 24A, when the picker first engages the pallet sled 412 and the mobile device 424 (optionally, after logging into the mobile device 424), the picker can choose a skill level on operator level screen 460. In the example shown the picker can choose from among three different levels. Alternatively, the user can choose from two levels or from more than three levels, or can choose a level on a slider. Alternatively, the picker's supervisor chooses the level based upon metrics collected by the mobile devices 424 on pallet sleds 412 and associated with each picker. The collected metrics can include one or more of number of pallets loaded, number of SKUs picked, rate of SKUs picked (e.g. SKUs per day or per hour), number of days worked, average speed in loading pallets, and accuracy in loading pallets. Alternatively, the level is determined automatically based upon the collected metrics. Based upon the user's level, the mobile device 424 may provide a different level of instruction and feedback, e.g. the mobile device 424 may provide reduced, more efficient instructions to the more experienced user, with less feedback, than to the novice picker.

Referring to FIG. 24B, the collected metrics can be reported to the picker at the beginning and end of the picker's shift and periodically throughout the day. The example gamification screen 462 in FIG. 24B provides feedback to the picker based upon the metrics. As shown in FIG. 24B, the reported metrics may set goals for the picker, such as SKUs to pick for the day and number of SKUs per hour. The reported metrics also track accuracy and that feedback is provided to the picker as well. A bonus may be offered at a certain level of production and accuracy, as shown. The reported metrics may also indicate the picker's ranking against other pickers. For example, the pickers may compete based upon production and/or accuracy for a day or a week, etc. Other metrics and ways of gamifying the metrics could also be used.

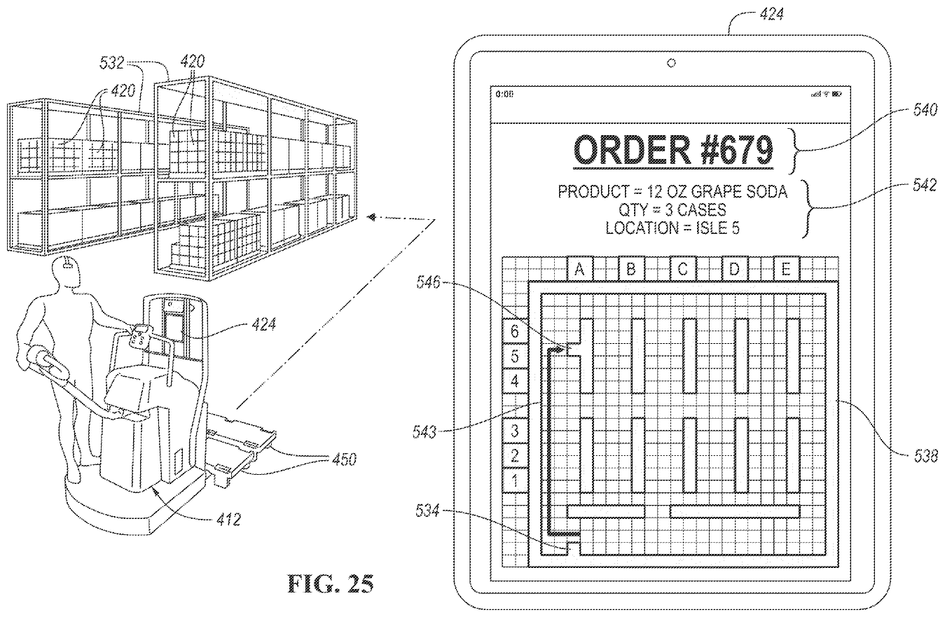

Referring to FIG. 25, the different products 420 are arranged on shelves 532 throughout the distribution center. The pick sheet 438, in this case for order number 679, is sent to the mobile device 424. The mobile device 424 displays the order number in an order number field 540. The mobile device 424 identifies the next product in a next product field 542 and displays a map 538 of the distribution center indicating the current location 534 of the pallet sled 412 and the item location 546 of the next product 420 to be loaded onto one of the pallets 450. The mobile device 424 may determine its position within the distribution center using known electronic and software methods. The mobile device 424 may indicate a route 543 from the current location 534 to the item location 546, such as shown in FIG. 25. The route 543 would take into account that at least some of the paths in the warehouse only permit travel in one direction (if applicable).

Alternatively, the mobile device 424 assumes that the user has guided the pallet sled 412 to the locations as directed by the mobile device 424 according to the displayed maps 538 and sequentially displays maps of how to get from one location to the next.

The remote CPU 430 (FIG. 21) has determined an exact desired arrangement of the products 420 on each pallet 450 and sends this information in the pallet configuration 440 file. The remote CPU 430 communicates the pick sheet 438 and pallet configuration 440 to the mobile device 424 along with the sequence of pick instructions. Alternatively, the mobile device 424 can determine the sequence of pick instructions based upon the pallet configuration 440 and optionally also based upon a stored map of the locations of the SKUs in the distribution center. As shown in FIG. 25, the mobile device 424 identifies the next item to be picked and the quantity in the next product field 542 and the location 546 of products 420 corresponding to that SKU on the map 538.

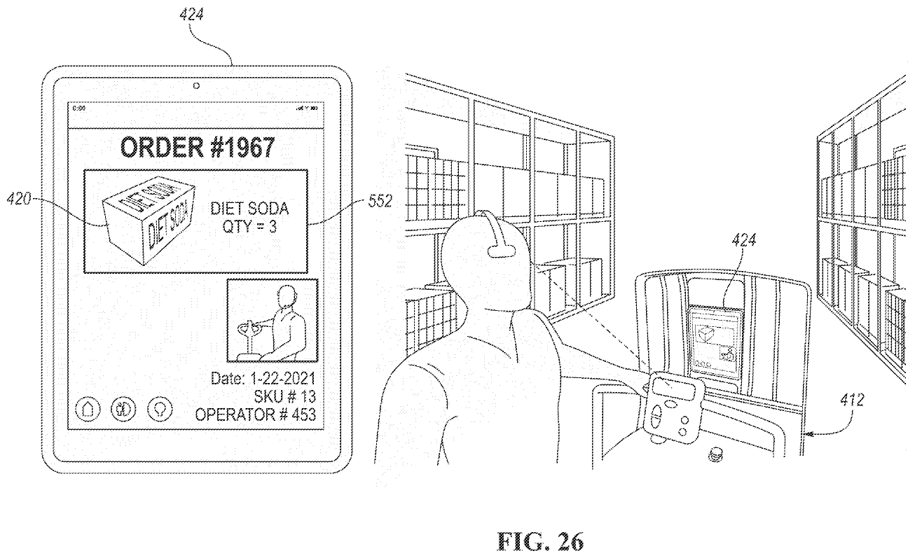

As shown in FIG. 26, the when the mobile device 424 determines that it is at the location 536 of the next product 420 (or when the user tells the mobile device 424 that it is), the mobile device 424 then displays a full color image 552 of the next product 420 to be picked (based upon SKU images 432) and the associated quantity on the rear-facing screen. This is particularly helpful when the packaging for the product 420 has changed (for example), so the picker can find the right product 420 quickly.

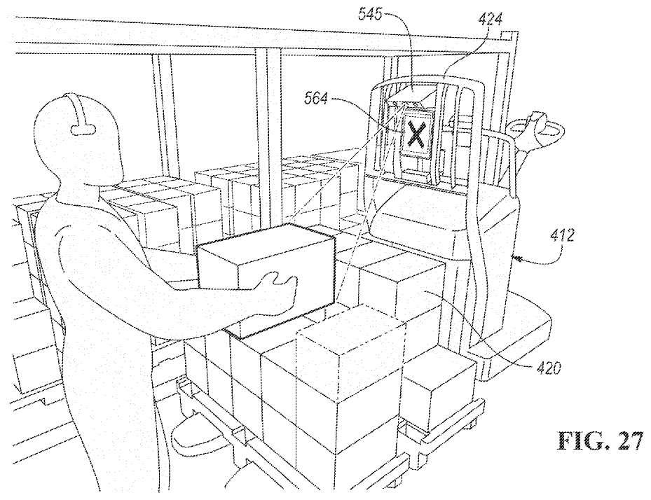

Referring to FIG. 27, using camera 545, the mobile device 424 may take images (stills or video) of each product 420 retrieved by the user as the user approaches the pallet sled 412, i.e. while the product 420 is still in the user's hands. The image may be sent to the remote CPU 430 as product image 442 (FIG. 21) or it may be processed locally by the mobile device 424. The mobile device 424 (or remote CPU 430) identifies each product 420 by SKU (such as by using a machine learning model trained on the available SKUs). The mobile device 424 checks to ensure that the identified SKU matches the SKU that the mobile device had indicated was the next product to be retrieved. If it matches, a confirmation screen is displayed. If it does not match, a rejection screen 564 is displayed on the mobile device 424 as shown in FIG. 27. The user returns the incorrect product 420 to the shelves and retrieves the correct product 420 and the mobile device 424 repeats the verification. This step is repeated for each of the required quantity of product 420 associated with the current SKU. If there are not enough products 420 associated with the current SKU in stock on the shelves, the user can so indicate this on the mobile device 424. This information is eventually passed on to the validation station.

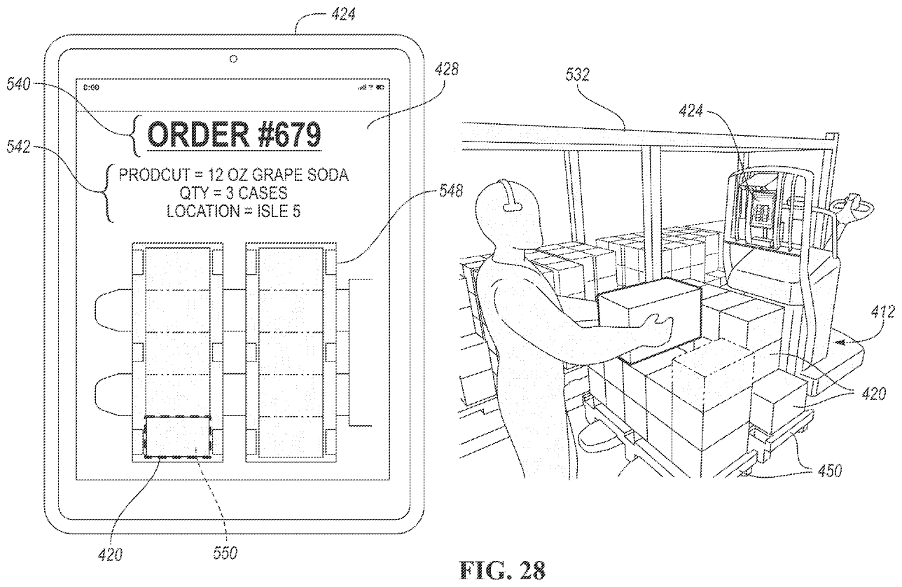

Referring to FIG. 28, if the mobile device 424 confirms that the correct product 420 has been retrieved, the mobile device 424 instructs the user exactly where on the pallets 450 to place the next product 420, including which pallet 450 and the location on that pallet 450. As shown, the front-facing touchscreen displays a loading instruction screen 548, which shows an image of the pallets 450 and tines and places an icon 550 at the location on the pallets 450 where the next product 420 should be placed. The user then places the product 420 on the pallets 450 according to the loading instruction screen 548. If more than one product 420 with this SKU is required, the mobile device 424 indicates the location for each product 420 sequentially, or alternatively, indicates all of the locations at once.

Note that both pallets 450 are being picked at the same time and each is associated with a different pick sheet 438. Therefore, the mobile device 424 may indicate that one or more products associated with a particular SKU should be placed on one pallet 450 and one or more products associated with the same SKU should be placed on the other pallet 450.

After retrieving the required number of products 420 at the first location, the mobile device 424 indicates the next location where the next product(s) 420 can be retrieved (similar to FIG. 25), and then the exact location(s) where the next product(s) 420 should be placed on the pallets 450 (similar to FIG. 28).

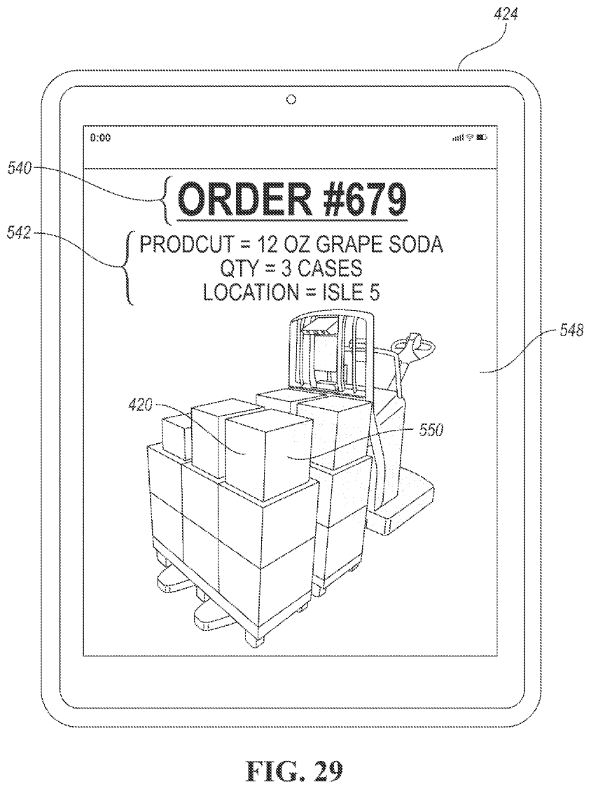

The user can choose to have the mobile device 424 build and display an updated 3D image of the pallets 450 and products 420 that have already been loaded as the loading instruction screen 548, as shown in FIG. 29. The mobile device 424 creates the 3D image from the stored SKU images 432 and the known locations of the already-loaded SKUs on the pallets 450. The mobile device 424 indicates the exact location for the next product 420 in the 3D image of the partially loaded pallets 450. Each of the previously-placed products 420 is displayed in full color on its proper location on the pallets 450. The next product 420 is displayed in its desired location relative to the previously-loaded products 420. The next product 420 is visually distinguished, such as by flashing, being outlined, being displayed translucently, being displayed in color while the loaded products 420 are displayed in greyscale (or at least reduced saturation), or other visual effect or some combination of such visual effects.

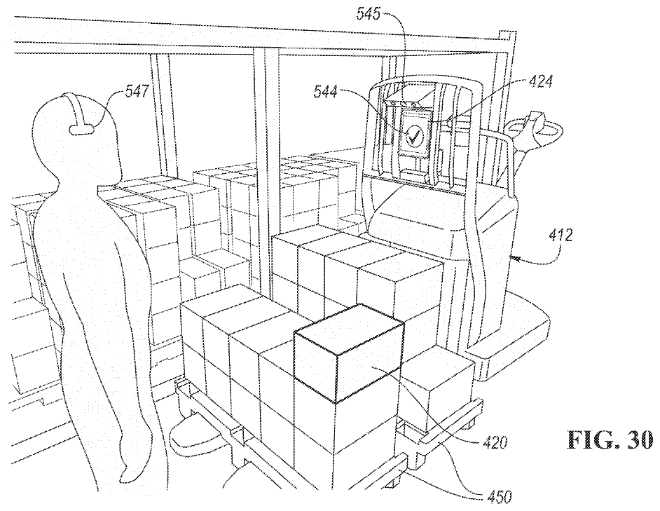

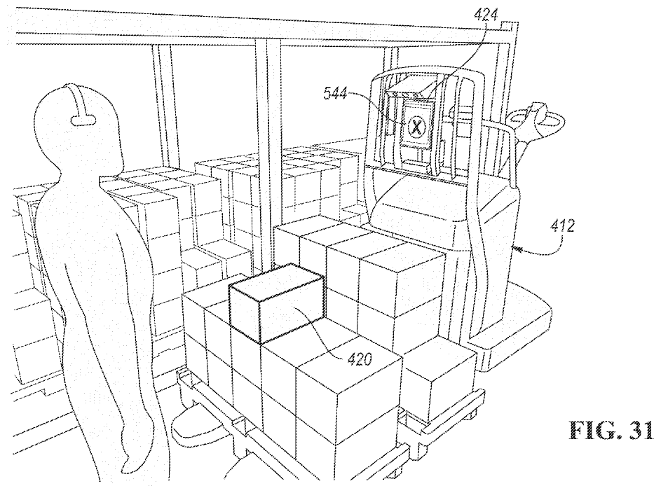

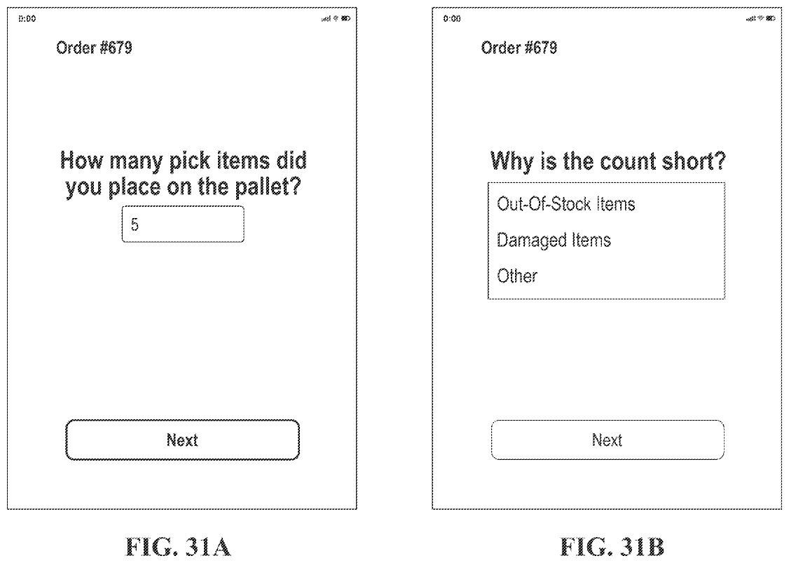

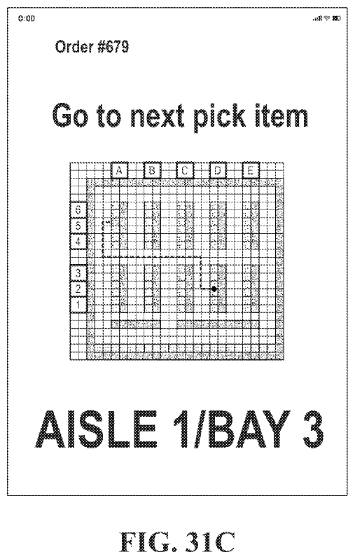

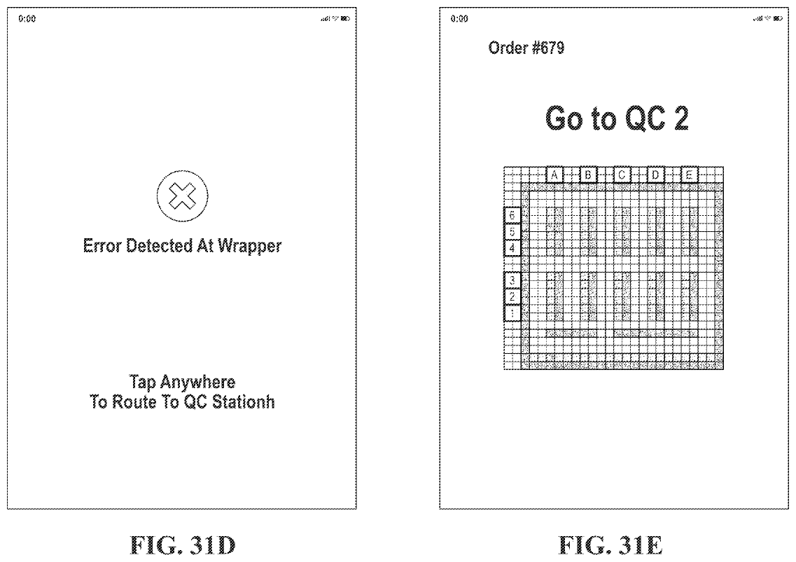

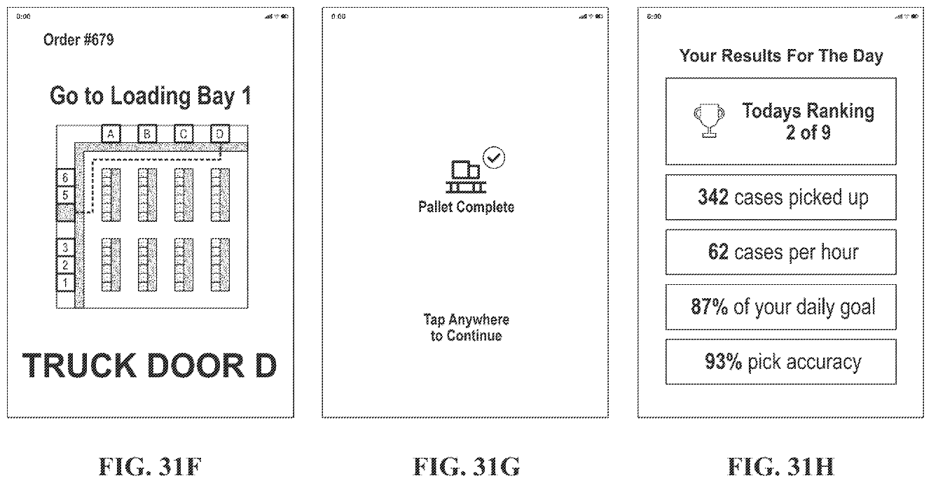

As shown in FIGS. 30 and 31, after the user places the next product 420, the mobile device 424 takes an image (or images) with camera 545 to verify that the product 420 is placed in the correct location on the pallets 450 and on the stack of products 420. This image may be sent to the remote CPU 430 as pallet image 444 it may be processed locally on the mobile device 424. Again, either confirmation (FIG. 30) or rejection (FIG. 31) is displayed. If a rejection is displayed, the mobile device 424 returns to a screen indicating the correct location (e.g. FIG. 28 or FIG. 29).

Optionally, if the mobile device 424 is not configured to verify that the correct product 420 was placed on the pallet 450, or if the mobile device 424 was simply unable to do so (temporarily), the mobile device 424 may ask the user to confirm the quantity of the desired product 420 that was placed on the pallet 450. Preferably the mobile device 424 asks the user over the headset 547 “How many pick items did you place on the pallet?” (or similar) and the user responds verbally with the count. Alternatively, the mobile device 424 can display the screen of FIG. 31A, which displays the text “How many pick items did you place on the pallet?” (or similar) and permits the user to enter number.

Whether through visual image verification, verbal interrogation of the user or text interrogation of the user, the mobile device 424 receives the count of the number of that product 420 that was placed on the pallet 450. If that count is lower than that on the pick list, then the mobile device 424 asks the user “Why is the count short?” either verbally or via the display, such as in FIG. 31B. The user can then answer (again verbally or via the pull-down menu in FIG. 31B), “out of stock items,” “damaged items,” or “other.” Other possible responses could also be configured.

The mobile device 424 then instructs the user via the display of FIG. 31C how to get to the next pick item. The steps of FIGS. 26 to 31 are repeated until both pallets 450 are loaded according to the pick sheets 438 and pallet configurations 440.

The confirmations, any uncorrected errors or rejections, and any missing SKUs (or insufficient quantities) are recorded and sent to the remote CPU 430 and associated with the specific pallets 450. Confirmations and uncorrected errors or rejections may be associated with specific SKUs at specific locations on the specific pallets 450. Later, at a validation station, images of the loaded pallet 450 may be taken and analyzed, such as by using a machine learning model, to verify that the SKUs on the pallet 450 match the SKUs on the pick sheet 438. Confirmations by the mobile device 424 on the pallet sled 24 can be used at validation as an input to validation, i.e. there is already a level of confidence that the correct SKUs are on the pallet 450 at the correct locations. Uncorrected problems are also passed along to the validation station so that they can be corrected there. Additionally, there may be a third state where the mobile device 424 was neither able to confirm nor reject with a high level of confidence. This is passed onto the validation station as well, along with the specific SKU(s) and location(s) on the pallets 450. The validation state will then ensure that it can confirm or reject the SKUs at the locations on the pallets 450, or flag it for manual confirmation.

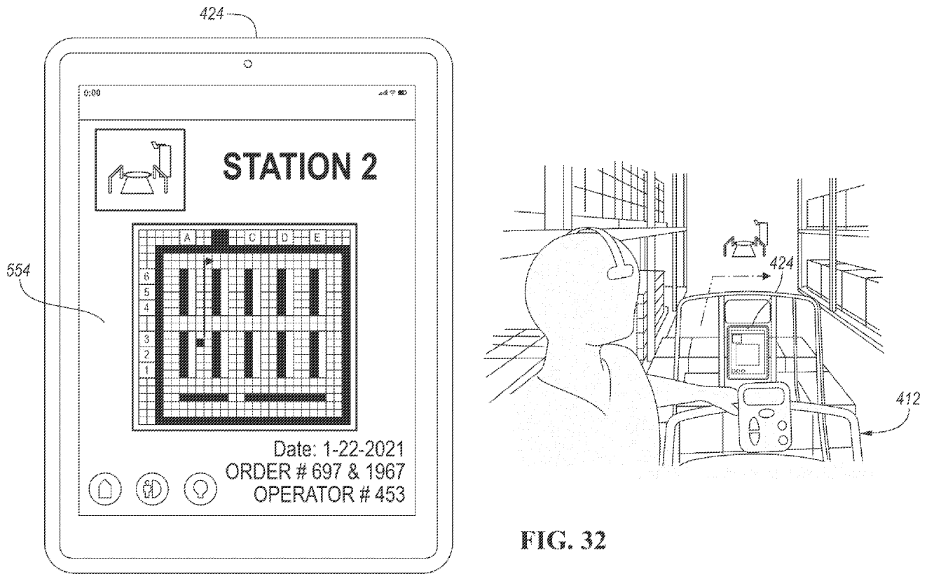

In FIG. 32, the mobile device 424 then displays a screen 554 instructing the picker which validation station to take the pallets 450. The validation station may be a wrapper or a dedicated validation station. The screen 554 may display a map of the distribution center with the location of the designated validation station. This ensures efficient use of the validation stations. The confirmation/rejection/unconfirmed status information discussed above is passed along to that validation station (but would be available to any validation station from remote CPU 430).

If an error is detected at the validation station (or wrapper), then the mobile device 424 may indicate the error on the screen as indicated in FIG. 31D and then instruct the user to take the pallet(s) 450 to a specified quality control station as indicated on the display, such as is shown in FIG. 31E.

If no errors are detected at the validation station (or after the errors are corrected), the mobile device 424 may instruct the user to take the pallet(s) to a particular loading bay and truck door, such as indicated in FIG. 31F.

After the user delivers the pallet(s) at the specified loading bay and truck door, the mobile device 424 may indicate that the pallet(s) is complete, such as the display of FIG. 31G. The mobile device 424 then indicates the user's statistics and ranking for the day, such as the example screen shown in FIG. 31H.

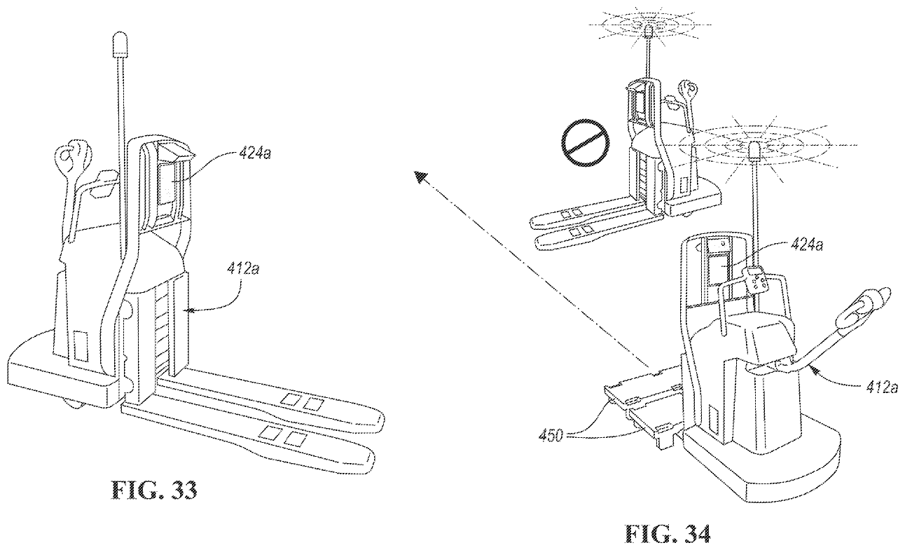

FIGS. 33 and 34 illustrate an alternative pallet sled 412a, which is identical to the pallet sled 412 but is also an automated guided vehicle. The pallet sled 412a is used in the manner described above but in addition, the pallet sled 412a automatically retrieves pallets 450 and follows a route from product to product, so that the picker or pickers can place the right products on the right pallet 450 (again, according to displayed instructions by the mobile device 424a). The picker may ride on the pallet sled 412a or there may be a different picker at each location in the distribution center.

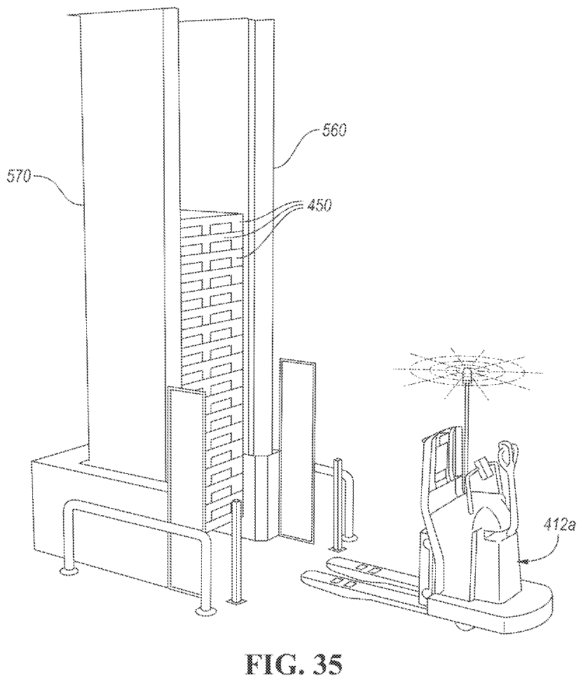

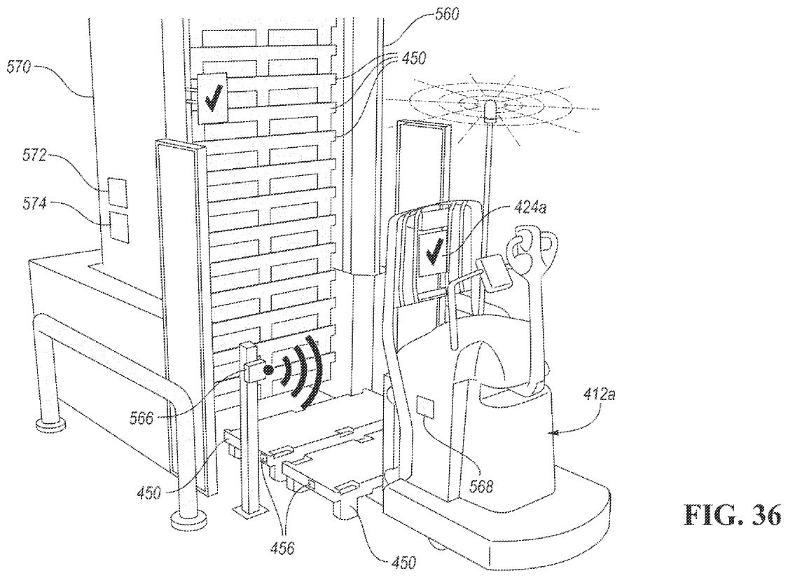

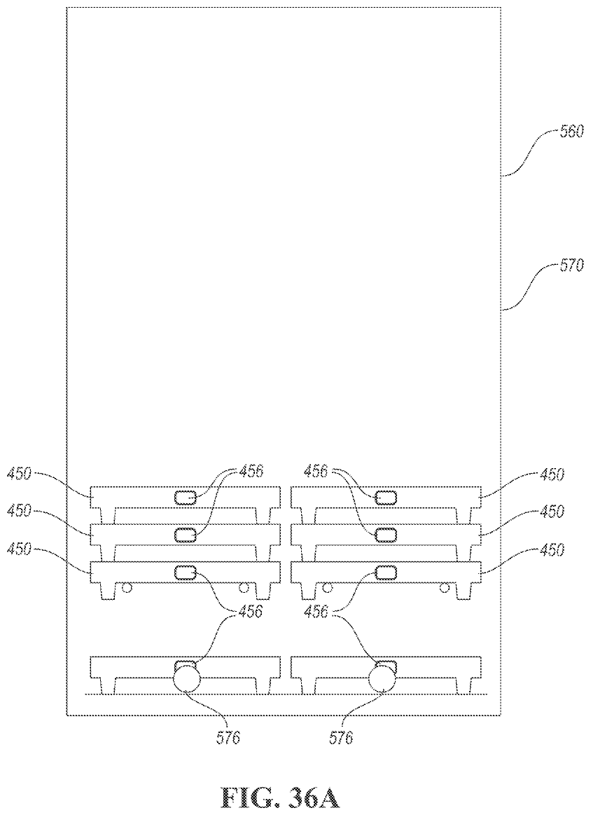

Referring to FIGS. 35 and 36, the pallet sled 412a retrieves two empty pallets 450 from a pallet destacker 560 (or “pallet dispenser”). The pallet destacker 560 includes a vertical body 570 for retaining a plurality of pallets 450. In this example, the pallets 450 are retained in the vertical body 570 two columns: a front column of pallets, not visible in FIGS. 35 and 36, and aback column of pallets 450, which is visible in FIGS. 35 and 36. The front column of pallets will be on the front ends of tines of the pallet sleds while the back column of pallets 450 will be toward the back of the tines of the pallet sleds.

When prompted, the pallet destacker 560, releases or dispenses two pallets 450 from the bottom of the stacks onto the floor or directly onto the tines 416a of the pallet sled 412a.

The pallet destacker 560 may include at least one processor 572 (together with electronic storage of data and instructions for causing the at least one processor 572 to perform the functions described herein). The pallet destacker 560 may also include a communication circuit 574, such as wifi, Bluetooth, NFC, etc. for communicating with the mobile device 424a of the pallet sled 412a directly or via the remote CPU 430. The pallet destacker 560 also includes a rfid reader 566 mounted on or near the pallet destacker 560 and connected to the at least one processor 572. In this example an rfid tag 568 on the pallet sled 412a can be read by the rfid reader 566.

FIG. 36A is a side view of the pallet destacker 560, broken away with some components shown schematically. As shown, the pallets 450 are retained in the vertical body 570 in two columns a front column of pallets (on the left in FIG. 36A) and a back column of pallets 450 (on the right in FIG. 36A). The front column of pallets will be end up on the front ends of tines of the pallet sleds while the back column of pallets 450 will end up toward the back of the tines of the pallet sleds.

As is known, lift tines 578 (or at least one tine or rod or pin or the like) are inserted by the pallet destacker 560 below the pallets 450 in each stack. The lift tines 578 are configured to be raised and lowered by a motor 580 or hydraulic actuator, etc. In use, the motor 580 lowers the two stacks of pallets 450 to the floor, then retracts the lift tines 578 and places them under the second-to-bottom pallets 450 in each stack. The motor 580 then raises the two stacks of pallets 450 other than the bottom-most pallet 450 in each stack, which remains on the floor.

In the pallet destacker 560, there are two rfid readers 576 aligned with the two dispensed pallets 450 on the floor below the two stacks. One rfid reader 576 reads the rfid tag 456 of the pallet 450 below one stack (on the left), which will be the next front pallet 450, and the other rfid reader 576 reads the rfid tag 456 of the pallet 450 below the other stack (on the right), which will be the next back pallet 450. This information is sent to the at least one processor 572, which may be transmitted via the communication circuit 574 to the pallet sled 412a. Alternatively, the rfid readers 576 could be placed adjacent the bottom pallet 450 in each stack. Alternatively, if identifiers other than rfid tags are used (NFC, barcodes, QR codes, etc), the rfid readers would be replaced with complementary readers (NFC readers, barcode readers, QR code readers, etc).

The tines of the pallet sled 412a, then enter from the front of the pallet destacker 560 (to the right in FIG. 36A), below the two pallets 450 on the floor. The pallet sled 412a then raises the tines to lift the two pallets 450 off the floor and then removes the pallets 450 from the destacker 560. Alternatively, the pallets 450 are dispensed directly onto the tines.

In this manner, the pallet sled 412a has the palled ids (SSCC) of each of the pallets 450 and knows which one is the front pallet 450 and which one is the back pallet 450. The at least one processor 570 also knows the pallet ids of the front pallet, the back pallet (and which is which) and the id of the pallet sled 412a now associated with those pallet ids. This information is transmitted to the server 14 and/or the DC computer 26 for use in the validation steps.

A pick list API downloads the customer's pallet details for all of their orders and includes a field for the picker name and the picker ID. Another API for Pick Assist receives the pick commands that are sent to the picker. The pick commands contain the SSCC number, Picker ID, along with the product and quantity of cases that they need to pick. In this way, the pallet SSCC numbers (pallet ids) are associated with the picker and/or the pallet sled 412a, and the specific pallet ids are associated with their respective pick lists (and again, it is known which pallet is front and which pallet is back).

There are a couple of ways to limit the possible pallets for a best match pick list algorithm once a pallet is placed on the wrapper for validation. The RFID tag from the pallet 450 will be read on the wrapper and then the validation station will have the SSCC value that identifies the pick list or have a limited number of possible SSCC pallets to pick from. For example, even if front/back could not be distinguished, then the validation station only needs to distinguish the two pallets that were picked at the same time. Or if only the Picker ID is known, then only the pallets that were picked by that picker need to be considered. The skus on the pallet are compared to the possible associated pick lists for a best match. The inferred skus on the pallet are then compared to that pick list as explained herein.

If the rfid reader 566 and/or rfid readers 576 are able to determine which pallet is on the front of the tines and which pallet is toward the rear of the tines, then the pallet 450 will be identified even before validation, but validation can also confirm which pallet 450 is at the validation station.

If it is not known which RFID tag belongs to the front pallet and which one belongs to the back pallet, then the validation station 32 can easily distinguish the two through comparison to the two associated pick lists. If there is more than one possible pallet for the pallet RFID value on the wrapper then a best match pick list algorithm looks at the list of possible pallets and selects the best matching pallet. The algorithm finds the best SSCC number that matches one in the list based on the inference results and the pick list for all of the pallets in the list. A score is given to each pallet and the pallet with the highest score is determined to be the most likely pallet. This SSCC number is then married to the pallet RFID value for Load Validation. The best matching pallet is also used for the display in SKU Verification for the results of the inference.

The number of possible pallets that could be on an individual wrapper is reduced in a few ways:

1) If the customer is able to provide the pick sequence of pallet SSCC numbers for each picker then the time that the three RFID tags were married together can be used to know that the pallet on the wrapper could either be a specific SSCC of a front pallet or the SSCC of the back pallet. If it can also be determined which RFID tag is from the front pallet and which one is from the back pallet at the rfid readers 566, 576 at the destacker, then the exact SSCC number for that pallet will be known.

2) Based upon the pick commands used to instruct the picker in loading the pallets, the number of possible pallets can be reduced to two (or if the customer is otherwise able to provide an echo of the pick commands). Again, if it can be determined which RFID tag is from the front pallet and which one is from the back pallet from the rfid readers 566, 576, then the exact SSCC number for that pallet will be known.

3) If this destacker 560 and validation are used without the pick assist invention, then there are many more possible pallets. However, first, the list of possible pallets will be restricted by all of the pallets that the picker is assigned to for the day. For example, if a picker is assigned to twenty pallets for the day then it is known that the pallet on the wrapper would be one of the twenty pallets. The closest match would be found from the twenty.

Again, if the destacker 560 and validation inventions are used with pick assist, then the picker is known because the picker logs into the mobile device 424, 424a assigned to the pallet sled 412, 412a. There is a configuration set for that mobile device 424, 424a with the RFID tag of the pallet jack that it is mounted on. If the destacker and validation are used without the pick assist invention, then preferably a user interface in at the validation station 32 will link the picker to the pallet sled 412, 412a.

Either way, the mobile device 424a knows which pallets 450 are on the pallet sled 412a and associates them with the pick lists 438. At the same time, the mobile device 424a receives the pallet configuration 440 for each of the pallets 450 on the pallet sled 24a.

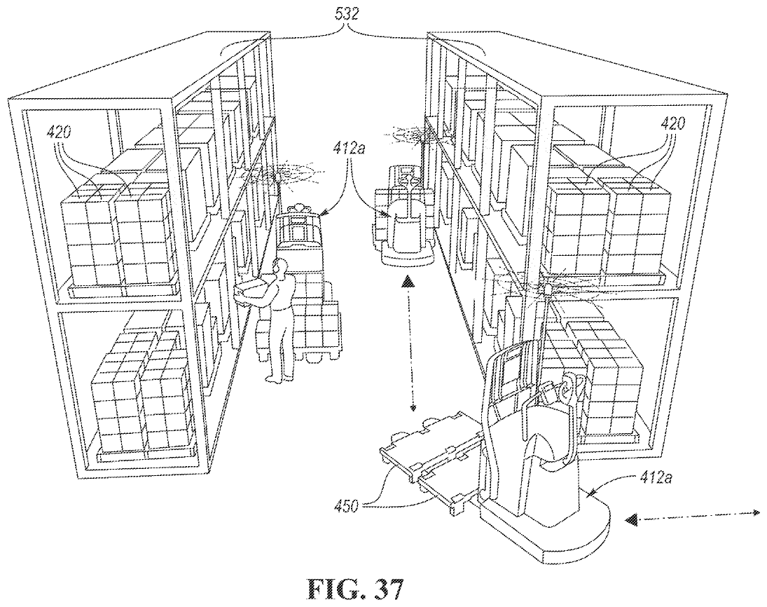

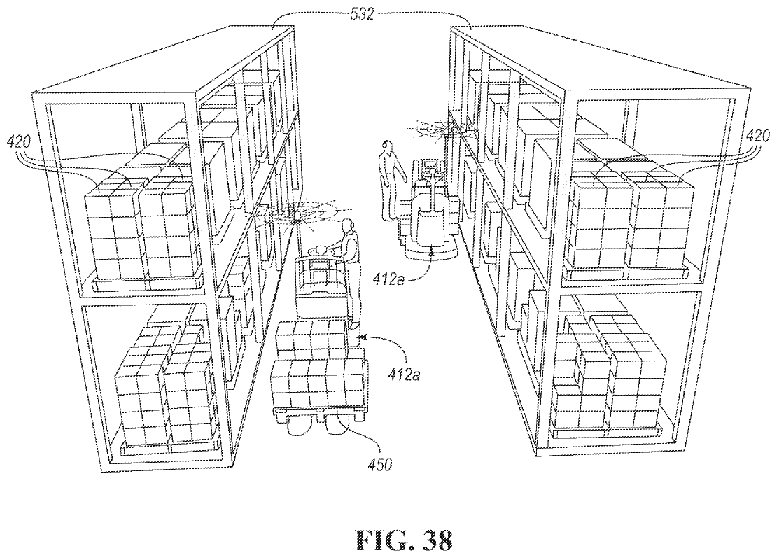

FIGS. 37 and 38 illustrate a particular method that can be used with the automated guided vehicle pallet sleds 412a. Referring to FIG. 37, for high-volume products 420, a picker can be stationed in the aisle near the high-volume products 420 and load each pallet sled 412a when it comes to the picker. As before, the picker would still view the mobile device 424a front facing screen to confirm the product 420 and to learn the quantity and where on the pallets 450 to place the product(s) 420.

In low volume zones as shown in FIG. 38, a picker would travel with (on) each pallet sled 412a to pick the products 420 for the pallets 450 on the pallet sled 412a as described above.

If both high-volume and low-volume zones are necessary to load the pallets 450 on the pallet sled 412a, the pallet sled 412a preferably obtains the high-volume products 420 first as described above with respect to FIG. 37 (without a picker riding or traveling with it), and then the pallet sled 412a picks up a picker who then travels with it to the low-volume zones to load the low-volume products 420.

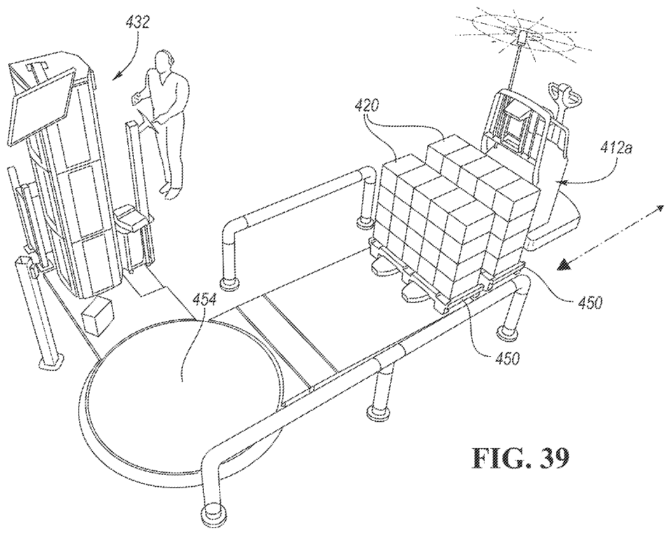

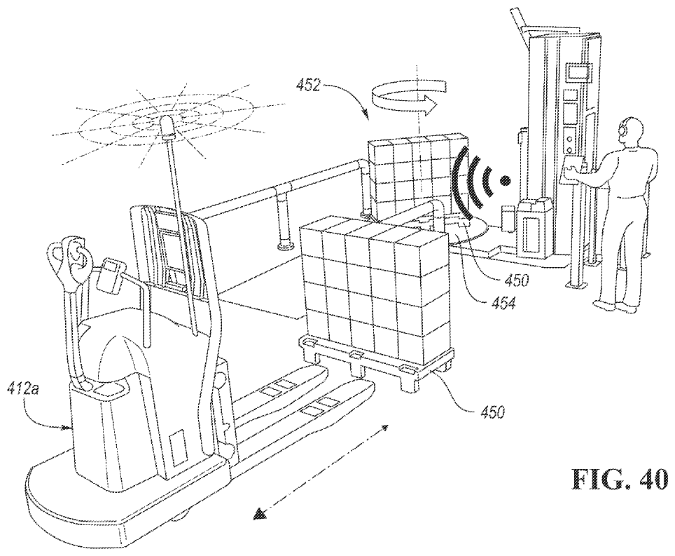

In FIG. 39, after the pallets 450 are loaded in any of the ways described above, the pallet sled 412a drops the loaded pallets 450 at the validation station 452. As shown in FIG. 40, the pallet sled 412a may leave one loaded pallet 450 on a turntable 454 for validation, while placing the other loaded pallet 450 nearby. The pallet sled 412a may then go to retrieve two more empty pallets from the destacker 560 (FIGS. 35 and 36).

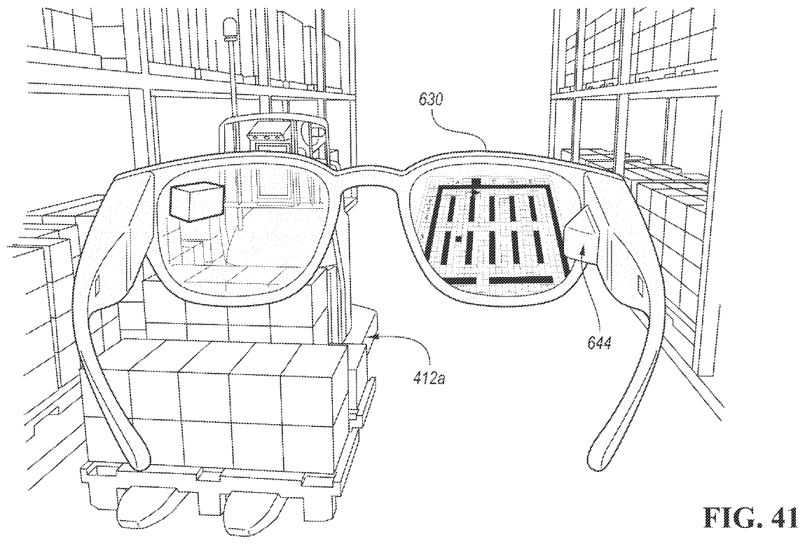

FIG. 41 illustrates a variation of the pick stations disclosed above in which smart glasses 630 are used as the mobile device instead of (or in addition to) a tablet/smart phone form factor. As shown in FIG. 41, the smart glasses 630 have a camera 644 and can display an indication of the next product to retrieve and a map to the next product but the automated guided vehicle pallet sled 412a already can drive itself to the right locations.

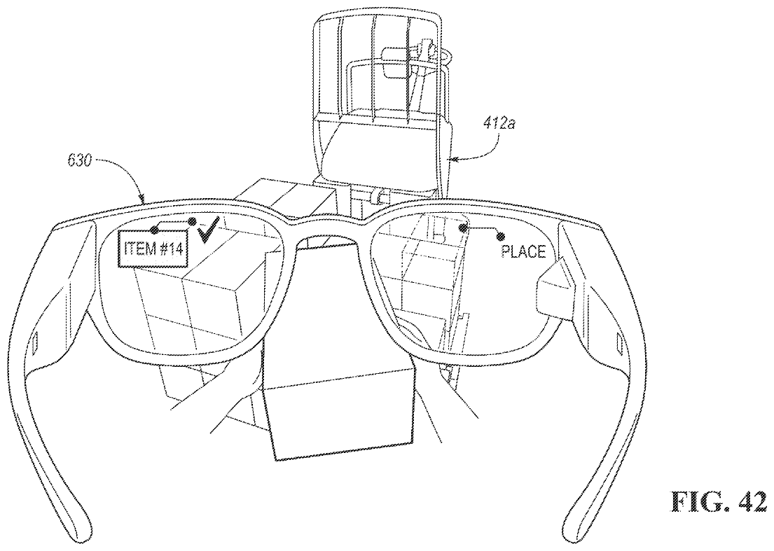

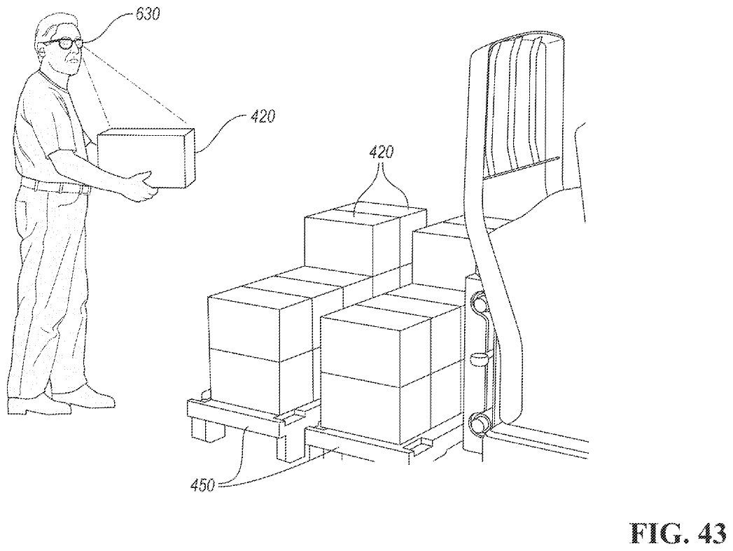

As shown in FIG. 42, the glasses 630 will naturally have a good field of view of each product 420 carried by the user so that the glasses 630 (possibly in conjunction with the mobile device 424a) can display a confirmation (or rejection) that the correct product has been selected. Using augmented reality, the glasses 630 can overlay an indication of where to place the next product onto the user's real, live view of the products 420 stacked on the pallet sled 412a. The smart glasses 630 also verify the location of the product 420 placed on the pallets 450 based upon image(s) from the camera 644. FIG. 43 is another view of the user wearing the glasses 630 and placing the next product 420 onto the pallets 450.

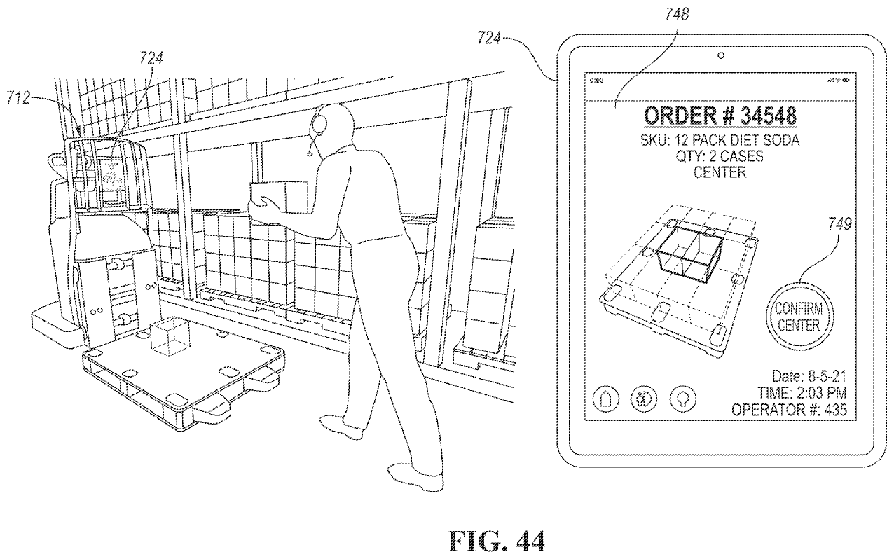

FIG. 44 shows a pallet sled 712 that may be identical to one of the pallet sleds 412, 412a described above. Alternatively, the pallet sled 712 does not include the camera that faces the tines. The mobile device 724 is identical to one of the mobile devices 424, 424a, with additional programming described here. As shown in FIG. 44, when loading a full-size pallet 722, there will be a plurality of products 20 in the center of each layer of products 20 on the pallet that will be hidden by other products 20 around the periphery of the pallet 722. These hidden products 20 will not be visible to cameras at the validation stations 32, 452 (any of the previously-described validation stations 32, 452 or variations thereon). Therefore, additional confirmation is performed during the picking process and this additional confirmation is passed onto the validation station.

FIG. 44 shows loading instruction screen 748 on mobile device 724 while the loading instruction screen 748 is instructing placement of two identical products 20 in the center area of the pallet 722. The loading instruction screen 748 includes a confirmation button 749 activatable by the picker touching the touchscreen. The picker touches the confirmation button 749 to confirm that the products 20 were placed in the center area of the pallet 722. The bottom layers is shown in FIG. 44, but this would be used for all layers. Alternatively, the picker can provide center confirmation in other ways, such as verbal feedback to the mobile device 724.

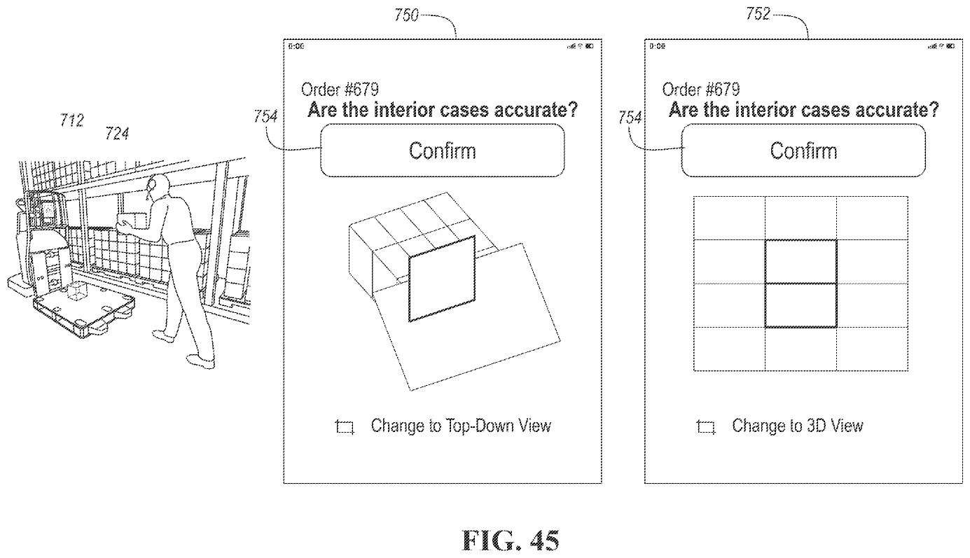

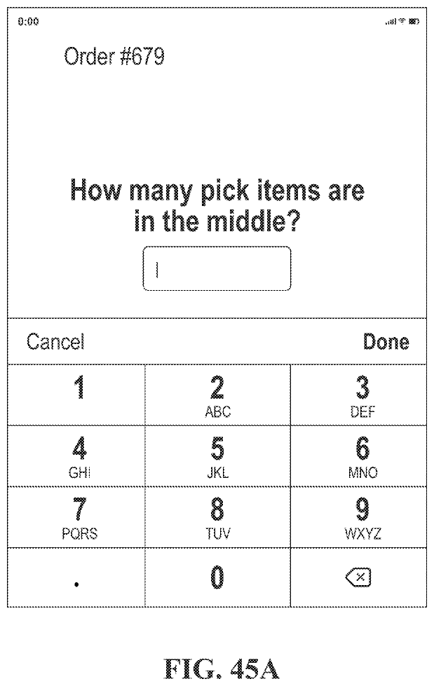

FIG. 45 shows two optional center confirmation screens 750, 752 that can be displayed on the mobile device 724 after the user provides center confirmation (FIG. 44) or instead of the center confirmation step of FIG. 44. In FIG. 45, the mobile device 724 shows the most-recently placed products 20 in the center area of the pallet 722 and asks the picker to confirm that the interior cases are correctly placed in the center area of the pallet 722 (which will be hidden from the cameras of the validation station) by touching the confirm button 754. The picker can toggle between the screen 750 and the screen 752.

Alternatively, if a tine-facing camera is provided (e.g. FIGS. 30 and 31), the tine-facing camera can provide confirmation of the center-placed products 20.

As another alternative, the mobile device 724 may interrogate the user audibly over the headset, or via the display shown in FIG. 45A, “How many pick items are in the middle?” and the use can either respond verbally over the headset or type in the number on the display.

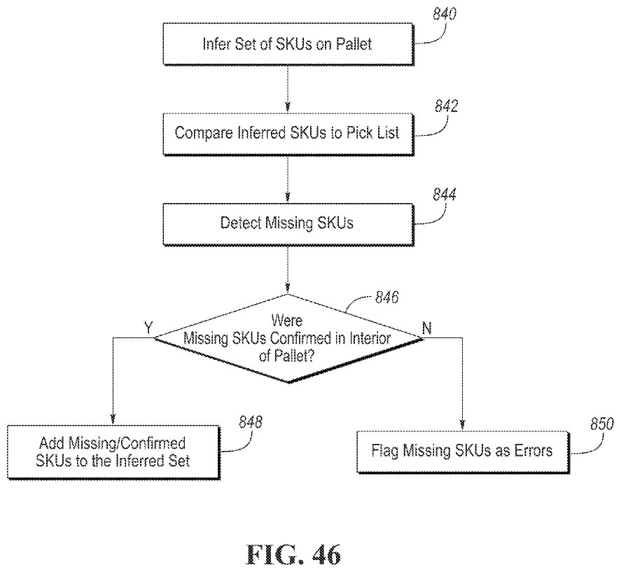

However the confirmation of the center-placed products 20 is made, that confirmation is passed on to the validation station 32 (FIG. 1) or validation station 452 (optionally via the DC computer 26 or the server 14). Referring to FIG. 46, in step 840 a set of SKUs on the pallet 722 is inferred at the validation station 32, 452 (according to the methods described above). In step 842, the inferred SKUs are compared to the pick list. In step 844, at least one but more likely a plurality of SKUs from the pick list are determined to be missing from the inferred SKU set. In step 846, it is determined whether each the missing SKUs was confirmed to be in the interior of the pallet 722 (e.g. according to FIG. 44 or 45, or automatically by the tine-facing camera of FIGS. 30 and 31). If so, then the SKUs that were missing but were confirmed in step 846 are added to the inferred set of SKUs in step 848. Any missing SKUs that were not confirmed as being in the interior of the pallet 722 are flagged as errors in step 850.

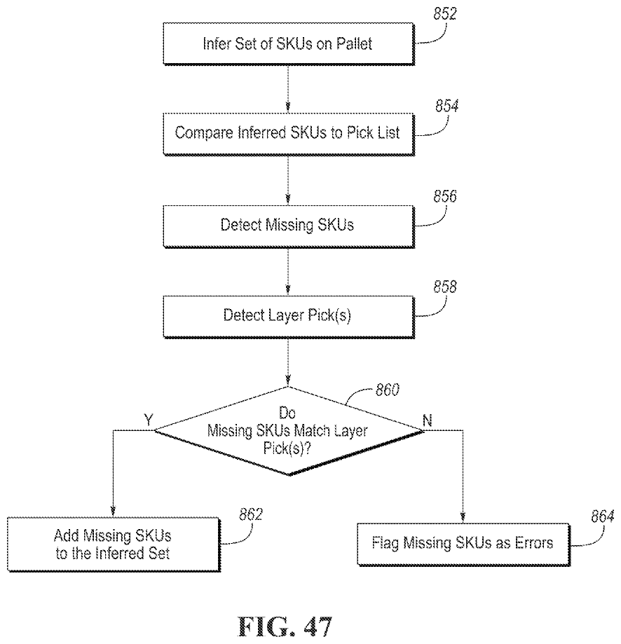

Another method for handling hidden products 20 is shown in FIG. 47. The method in FIG. 47 determines whether missing SKUs are likely in a “layer pick” of products 20 on the pallet 722. A layer pick is when the entire layer on the pallet 722 is the same product 20 (same SKU), e.g. all the same package type and all the same brand. In step 852, a set of SKUs is inferred at the validation station (according to the methods described above). In step 854, the inferred set of SKUs is compared to the pick list. In step 856, missing SKUs (SKUs on the pick list but not inferred by the methods described above) are detected. In step 858, it is determined whether there is a layer pick. A layer pick may be determined, at least in part, based upon a determination that all of the visible products 20 on one layer on the pallet 722 are the same SKU. If so, then in step 860 it is determined whether the missing SKUs match the SKUs on the layer picked layer (“match” in terms of both SKU and quantity of products). If so, then the missing SKUs are added to the inferred set (no error) in step 862. If the SKUs do not match the SKUs in the layer-picked layer, then the missing SKUs may be flagged as an error in step 864. Optionally, weight could be factored into the determination as to the presence of the missing SKUs in the interior of the pallet (as described above).

Further, the confirmation of SKUs in the interior of the pallet could be used in conjunction with the method of FIG. 47.

Alternatively, a determination that almost all of the visible products 20 on one layer on the pallet 722 are the same SKU (some threshold less than 100% of the visible products 20) could also be used to determine that there is a likelihood that the “missing SKUs” in the interior of the pallet 722 match the visible products 20 on the visible exterior of the pallet 722.

Using one of the computers or a mobile device, a user can create a map of the warehouse using a map-creation tool. The created map of the warehouse would then be used to help the picker navigate to each product as shown above.

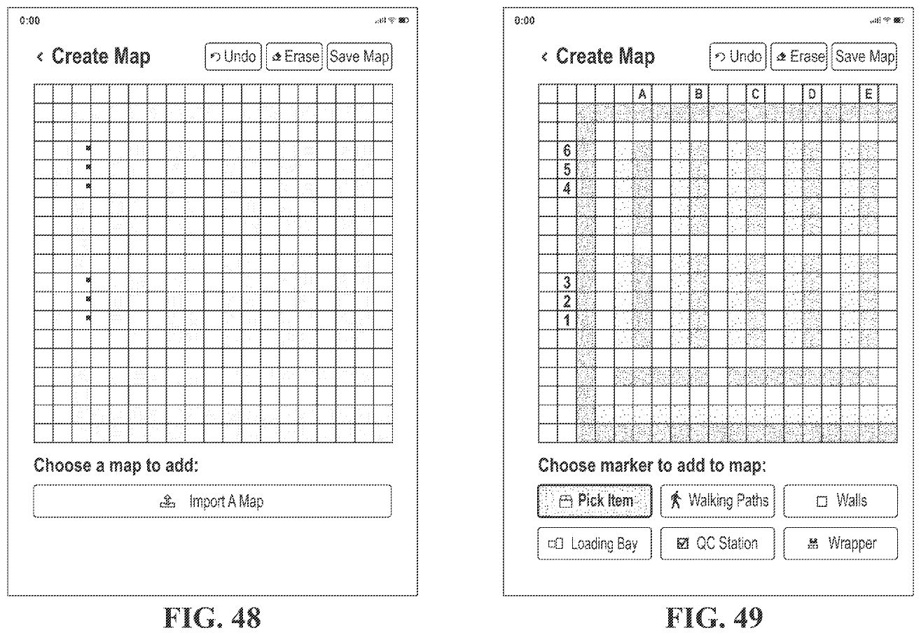

In FIG. 48, the user creates the map or imports an existing map (to modify an existing map or copy an existing map to modify it for a new map). As shown in FIG. 49, the user can choose from among several marks to place on the map: Pick Item (i.e. the location of SKUs), Walking Paths, Walls, Loading Bay, QC Station, and Wrapper.

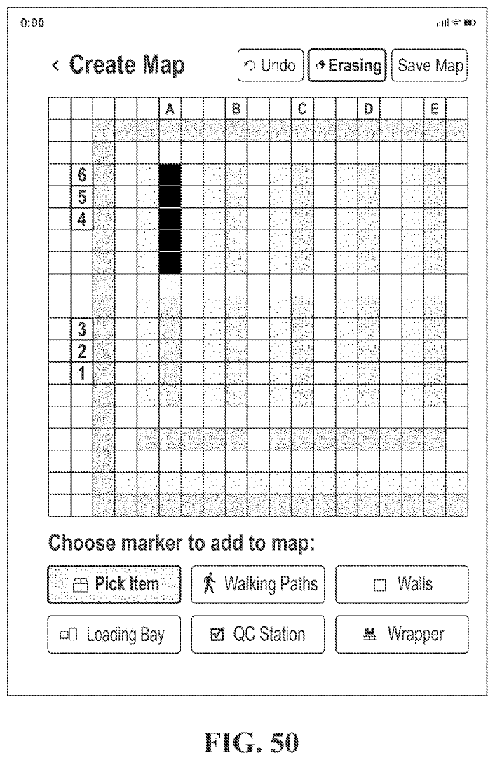

In FIG. 50, the user has selected “Pick Item” and is adding a pick item (a SKU location) to the map. The user would then be able to assign a particular SKU to that location on the map.

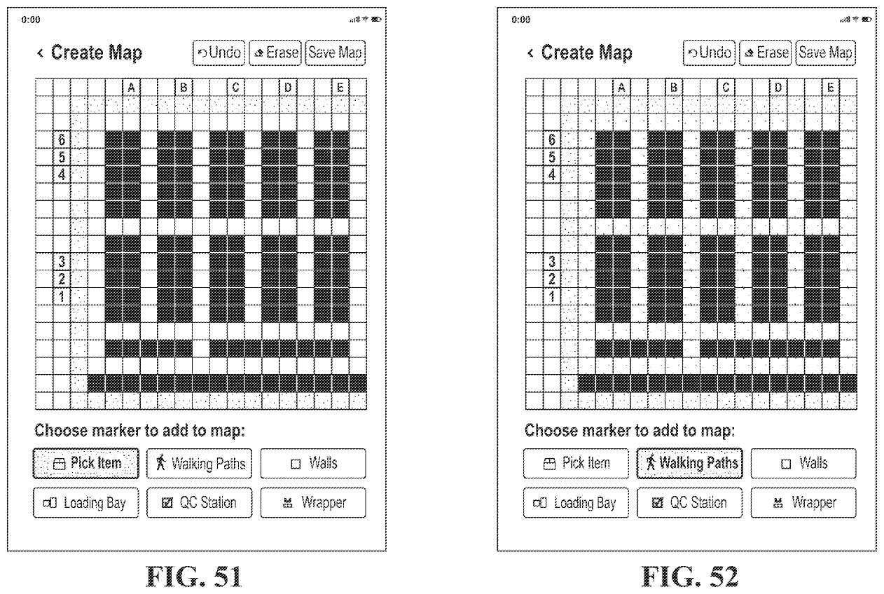

In FIG. 51, the user has added all of the Pick Items to the map. In FIG. 52, the user has selected “Walking Paths” and has added the walking paths (between the pick items) to the map. The user is able to designate some or all of the walking paths as permitting travel in a single direction (one-way).

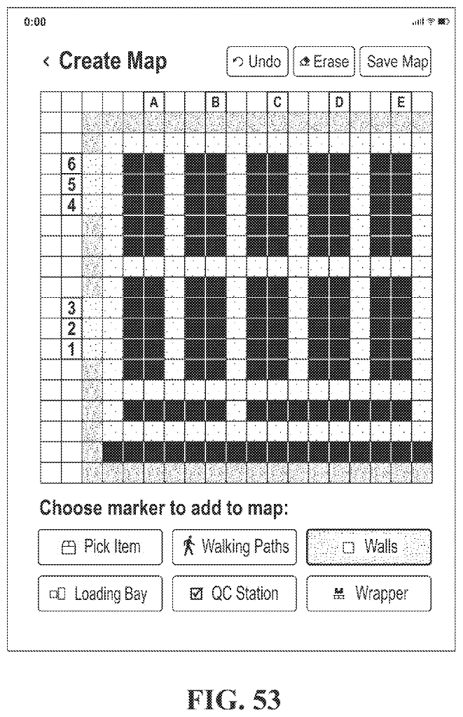

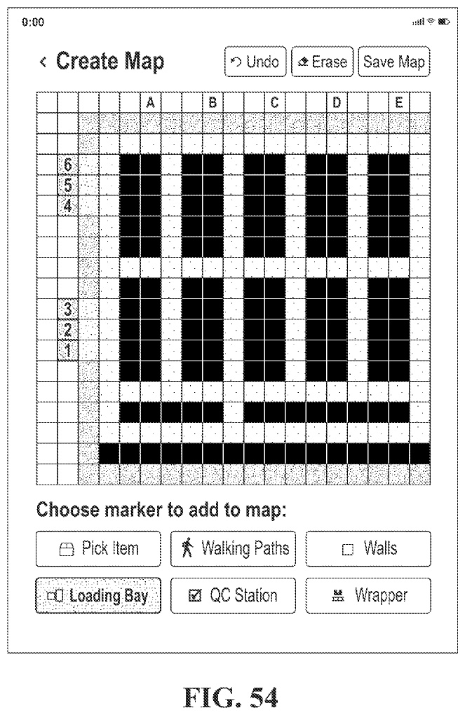

In FIG. 53, the user has selected “Walls” and is adding the walls to the map, leaving openings for the loading bays, for example.

In FIG. 54, the user has selected “Loading Bay” and has added six loading bays to the map. Each loading bay is identified in the map so that the picker can be routed to a specific loading bay as explained previously.

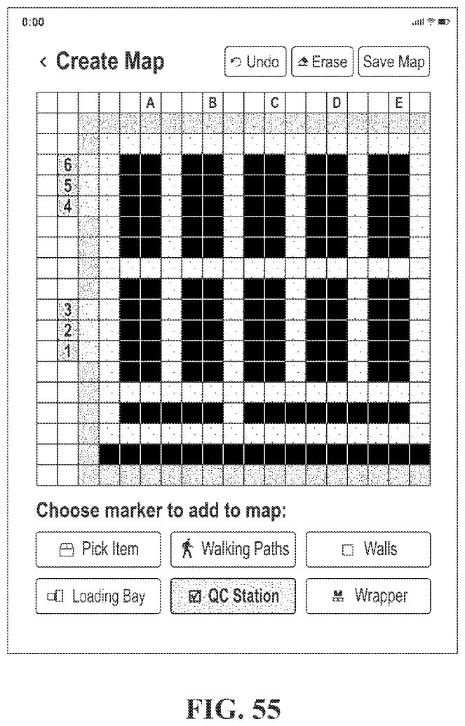

In FIG. 55, the user has selected “QC Station” and has identified the locations of several QC stations, each being labeled A-E, so that a picker can be routed to a specific QC station as explained previously.

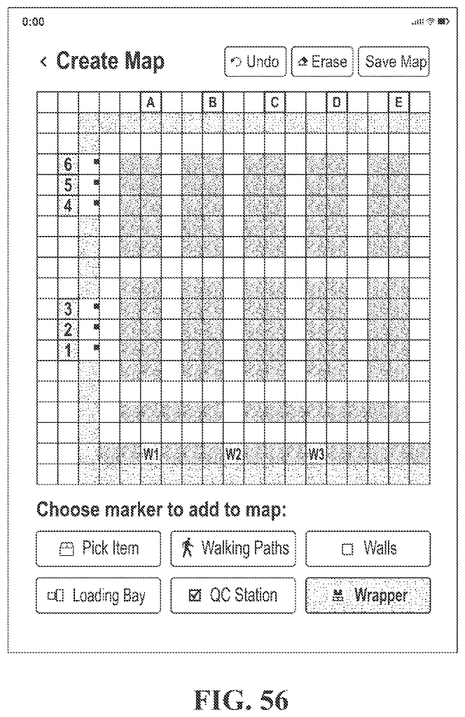

In FIG. 56, the user has selected “Wrapper” and has identified the locations of three wrappers W1-W3, so that a picker can be routed to a specific wrapper as explained previously.

As shown, the user is also provided “Undo,” “Erase,” and “Save” buttons.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. Alphanumeric identifiers on method steps are solely for ease in reference in dependent claims and such identifiers by themselves do not signify a required sequence of performance, unless otherwise explicitly specified.

What is claimed is:

1. A pallet destacker comprising:
a vertical body configured to store a front column of pallets and a back column of pallets therein; and
at least one rfid reader for reading an rfid tag on a pallet in or below at least one of the front column of pallets or the back column of pallets.

2. The pallet destacker of claim 1 wherein the at least one rfid reader includes a front rfid reader positioned to read the rfid tag of a pallet in or below the front column of pallets and a back rfid reader positioned to read the rfid tag of a pallet in or below the back column of pallets.

3. A delivery system including the pallet destacker of claim 1 in combination with a validation system including at least one camera for imaging a plurality of items stacked on a pallet and at least one processor programmed to identify skus of the plurality of items stacked on the pallet based upon images from the at least one camera, wherein the at least one processor is programmed to compare the identified skus to a list of desired skus based upon a pallet id of the pallet, wherein the at least one processor is programmed to identify the pallet id of the pallet based upon the rfid tag on the pallet read by the at least one rfid reader in the destacker.

4. A method for dispensing pallets including:
a) storing a plurality of pallets including a bottom pallet in a stack;
b) lifting the plurality of pallets other than the bottom pallet off the bottom pallet;
c) reading an identifier on the bottom pallet; and
d) moving the bottom pallet laterally away from the stack.

5. The method of claim 4 wherein step d) is performed during step c).

6. The method of claim 4 wherein step d) is performed after step c).

7. The method of claim 4 wherein the stack is a first stack and wherein steps b), c) and d) are performed with respect to a second stack while steps b), c) and d) are performed with respect to the first stack.

8. The method of claim 7 wherein step c) includes reading an rfid tag.

9. The method of claim 8 wherein step d) includes lifting the bottom pallets of the first stack and the second stack on tines of a pallet sled, such that the bottom pallet of the first stack is a front pallet and the bottom pallet of the second stack is a back pallet on the tines of the pallet sled.

10. The method of claim 9 further including e) communicating the identifiers to at least one processor on the pallet sled, including associating the identifier of the front pallet to the front pallet and associating the identifier of the back pallet to the back pallet.

11. The method of claim 4 wherein step c) includes reading an rfid tag.

12. The method of claim 11 wherein step d) includes lifting the bottom pallet on tines of a pallet sled.

13. The method of claim 12 further including e) communicating the identifier to at least one processor on a pallet sled.

14. A method for loading and verifying a pallet including:
a) indicating on a display on a pallet sled a product to be retrieved; and
b) determining that the product has been placed in a center of a pallet on the pallet sled.

15. The method of claim 14 wherein step b) includes receiving a confirmation from a user that the product has been placed in a center of the pallet.

16. The method of claim 14 wherein step b) includes instructing a user to place the product in the center of the pallet.

17. The method of claim 14 wherein the product is a first product, the method further including:
c) placing a plurality of products including the first product in a stack on the pallet such that the first product is not visible from an exterior of the stack, wherein the plurality of products includes a plurality of exterior products that are visible from the exterior of the stack;
d) receiving a plurality of images of the stack;
e) identifying skus of each of the plurality of exterior products in the stack;
f) determining a sku of the first product based upon steps a) and b); and
g) comparing the skus of the plurality of exterior products and the sku of the first product to a list of desired skus.

18. The method of claim 17 wherein step b) includes receiving a confirmation from a user that the product has been placed in a center of the pallet.

19. The method of claim 17 wherein step b) includes instructing a user to place the product in the center of the pallet.

20. The method of claim 14 further including:
c) determining that the product was in a layer pick;
wherein the determination in step b) is based upon the determination of step c).

21. A method for loading and verifying a pallet including:
a) indicating on a display on a pallet sled a desired number of a product to be retrieved;
b) asking a user for a count of how many of the product was retrieved;
c) comparing the count to the desired number of the product; and
d) based upon step c), asking the user why the count is less than the desired number.

22. The method of claim 21 wherein step d) is performed using the display.

23. The method of claim 22 wherein step d) includes providing a menu of a plurality of reasons why the count might be low.

24. A method for verifying a pallet including:
a) receiving a plurality of images of a plurality of products in a stack, wherein the plurality of products includes a plurality of exterior products that are visible from the exterior of the stack;
b) using at least one processor, identifying skus of each of the plurality of exterior products in the stack, including a plurality of exterior products in a layer;
c) determining that the skus of each of the plurality of exterior products in the layer are the same; and
d) based upon step c), determining that at least one interior product not visible in the plurality of images has the same sku as the plurality of exterior products.

25. The method of claim 24 wherein the plurality of exterior products in the layer are all of the exterior products in the layer.

26. The method of claim 24 further including:
e) comparing the skus of the plurality of exterior products and the sku of the at least one interior product to a list of desired skus.

27. The method of claim 26 wherein step b) includes the at least one processor inferring the skus of each of the plurality of exterior products using at least one machine learning model.
